(19) United States
(12) Patent Application Publication
(10) Pub. No.: US 2014/0302989 A1
(43) Pub. Date: Oct. 9, 2014

(54) METHODS OF CONTROLLING WEEDS WITH THAXTOMIN AND THAXTOMIN COMPOSITIONS IN COMBINATION WITH A BENEFICIAL HERBICIDE

(71) Applicant: NOVOZYMES BIOAG A/S, Bagsvaerd (DK)

(72) Inventors: Scott Inman, Loveland, CO (US); Shawn Semones, Salem, VA (US)

(21) Appl. No.: 14/355,133

(22) PCT Filed: Oct. 30, 2012
(86) PCT No.: PCT/US2012/062615

§ 371 Date: Apr. 29, 2014

Related U.S. Application Data
(60) Provisional application No. 61/553,369, filed on Oct. 31, 2011.

(51) Int. Cl. A01N 63/02; A01N 47/18; A01N 33/18; A01N 37/18

(52) U.S. Cl. CPC A01N 63/02; A01N 37/18; A01N 47/18; A01N 33/18
USPC 504/117

(57) ABSTRACT

Methods and composition for controlling weeds by contacting weeds or an environment susceptible to growth by a weed population with one or more thaxtomins and one or more herbicides are disclosed. One or more thaxtomins and one or more herbicides are applied to weed contaminated environments or environments susceptible to weed contamination in a predetermined amount for controlling, reducing and/or killing weeds.

### BACKGROUND

1. Technical Field

This disclosure relates to treating weeds with one or more thaxtomins in combination with one or more herbicides. The methods are useful for application to terrestrial environments in need of treatment to control, minimize and/or eliminate weeds.

2. Background

Many important terrestrial environments contain a substantial population of weeds which inhibit or prevent the growth of desired plants. These weeds are a nuisance in human-controlled environments. Weeds contribute to diminished plant growth and yields, especially among crop plants, in a variety of ways, including but not limited to, utilizing limited nutrients and/or resources in the soil, restricting access to light, and/or transmitting plant diseases through the harboring and spreading of plant pathogens. Further still, weeds contribute to an appearance that many observers find unattractive.

Currently used methods of controlling weed growth include treating weeds with herbicides. The most common herbicides are chemical herbicides and include pre-emergent and post-emergent herbicides. Examples of common chemical herbicides include pendimethalin; 3,4-Dimethyl-2,6-dinitro-N-pentan-3-yl-aniline; N-(1-ethylpropyl)-2,6-dinitro-3,4-xylidine; pronamide; propyzamide; 3,5-Dichloro-N-(1,1-dimethylpropynyl)benzamide; 3,5-Dichloro-N-(1,1-dimethyl-2-propynyl)benzamide; N-(1,1-Dimethylpropynyl)-3,5-dichlorobenzamide; S-ethyl N-ethylthiocyclohexanecarbamate; trifluralin; 2,6-Dinitro-N,N-dipropyl-4-(trifluoromethyl)aniline; glyphosate; N-(phosphonomethyl)glycine; and derivatives thereof.

Natural and organic herbicides are also used for weed control. Examples of natural herbicides include, but are not limited to, using corn meal gluten, acetic acid (i.e., vinegar), heat treatments (e.g., steam of flame), D-limonene (i.e., citrus oil), and monocerin, a fungal metabolite. See, for example, Monocerin, a Phytotoxin from Exserohilum turcicum, Agric. Biol. Chem., Vol. 46, 2681-83, 1982. Thaxtomin A, and other structurally similar compounds, have also been mentioned for controlling weeds. See, U.S. Patent Application Publication No. 2010/0167930 which discloses using Thaxtomin A and other structurally similar compounds as natural herbicides to control the germination and growth of weeds in cereal, turf grass Timothy grass, and pasture grass cultures.

Thaxtomins are a known group of phytotoxins; however, although thaxtomin A and analogues thereof demonstrate many of the biological properties desirable in potential herbicides, they are known to lack the systemic phytotoxicity critical to deliver reliable weed control in the field at low herbicide rates. See, for example, Herbicidal Properties of the Thaxtomin Group of Phytotoxins, J. Agric. Food Chem., Vol. 49, No. 5, 2001.

Weeds continue to be problematic to the farmer, landscaper, and homeowner alike. Continuous retreatment of environments with the exclusive use of chemical compounds increases the overall cost of treatment, and increases the potential for toxic accumulation of the herbicide in the environment. Thus, there is a continuing need for new herbicides as well as methods for using and making existing herbicides and formulations more effective at lower application rates.

### SUMMARY OF THE INVENTION

Accordingly, the inventors have found that the use of one or more thaxtomins, or analogues thereof, in combination with chemical herbicides improves the weed control spectrum, enhances crop safety, and reduces chemical herbicide usage without reducing weed control efficacy. The present disclosure provides, in one aspect, a method of treating weeds comprising contacting the weeds with one or more thaxtomins, or analogues thereof, and one or more herbicides. In one embodiment, the method of treating weeds comprises contacting the weeds with an effective amount of one or more thaxtomins, or analogues thereof, and an effective amount one or more herbicides. In a particular embodiment, the weeds are pre-emergent weeds. In one embodiment, the one or more herbicides may include pronamide (known also as propyzamide), cycloate, trifluralin, or combinations thereof.

In another aspect, the invention of the present invention includes a method of controlling the growth of weeds comprising contacting the weeds with one or more thaxtomins and one or more herbicides. In one embodiment, the method of controlling the growth of weeds comprises contacting the weeds with an effective amount of one or more thaxtomins, or analogues thereof, and an effective amount one or more herbicides. In a particular embodiment, the weeds are pre-emergent weeds. In one embodiment, the one or more herbicides may include pronamide (known also as propyzamide), cycloate, trifluralin, or combinations thereof.

In yet another aspect, the invention of the present invention includes a method of killing weeds comprising contacting weeds with thaxtomin A and one or more herbicides. In one embodiment, the method of killing weeds comprises contacting the weeds with an effective amount of one or more thaxtomins, or analogues thereof, and an effective amount one or more herbicides. In a particular embodiment, the weeds are pre-emergent weeds. In one embodiment, the one or more herbicides may include pronamide (known also as propyzamide), cycloate, trifluralin, or combinations thereof.

In still yet another aspect, the invention of the present invention includes a method of controlling weeds by applying to a soil one or more thaxtomins and one or more herbicides. In one embodiment, the method of controlling weeds comprises contacting the soil with an effective amount of one or more thaxtomins, or analogues thereof, and an effective amount one or more herbicides. In a particular embodiment, the weeds are pre-emergent weeds. In one embodiment, the one or more herbicides may include pronamide (known also as propyzamide), cycloate, trifluralin, or combinations thereof.

In still another aspect, the invention of the present invention includes a method of controlling weeds by applying one or more thaxtomins and one or more herbicides to an area in need of weed control. In one embodiment, the method of controlling weeds comprises applying an effective amount of one or more thaxtomins, or analogues thereof, and an effective amount one or more herbicides. In a particular embodiment, the weeds are pre-emergent weeds. In one embodiment, the one or more herbicides may include pronamide (known also as propyzamide), cycloate, trifluralin, or combinations thereof.

In another aspect, the one or more thaxtomins has the following composition:

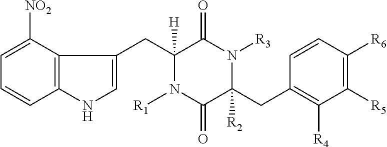

wherein R₁ is methyl or H, R₂ is hydroxy or H, R₃ is methyl or H, R₄ is hydroxy or H, R₅ is hydroxy or H, R₆ is hydroxy or H, and combinations thereof. In another embodiment, R₁ is methyl, R₂ is hydroxy, R₃ is methyl, R₄ is H, R₅ is hydroxy and R₆ is H.

### DEFINITIONS

As used herein, the singular forms “a”, “an” and “the” are intended to include the plural forms as well, unless the context clearly indicates otherwise.

As used herein “weed(s)” refers to plants which inhibit or prevent the growth of desired plants and/or diminish plant yields (e.g., by utilizing limited nutrients and/or resources in the soil, restricting access to light, and/or transmitting plant diseases through the harboring and spreading of plant pathogens). The term “weed(s)” is intended to include weeds at all growth stages (e.g., pre-emergent weeds).

As used herein, the term “pre-emergent weed” is intended to refer to a weed or weeds that has not emerged from the soil.

As used herein the word “treat,” “treating” or “treatment” refers to using the one or more thaxtomins in combination with the one or more herbicides of the present disclosure prophylactically to prevent, eliminate, inhibit, and/or kill undesirable weeds in an environment intended to be absent of weeds, or to ameliorate an existing weed population. A number of different treatments are now possible, which control, reduce and/or eliminate weeds.

As used herein, the term “control,” “controls,” “controlled,” or “controlling” is intended to mean prevent, reduce, or eliminate.

As used herein, the term “herbicide” is intended to refer to one or more agents, compounds and/or compositions having herbicidal and/or herbistatic activity.

As used herein, the term “herbicidal” is intended to mean the killing of weeds.

As used herein, the term “herbistatic” is intended to mean inhibiting the growth of weeds, which can be reversible under certain conditions.

As used herein “lower alkyl” refers to branched or straight chain acyclic alkyl group including one to about eighteen carbon atoms. Exemplary alkyl groups include, inter alia, methyl, ethyl, n-propyl, isopropyl, n-butyl, isobutyl, sec-butyl, pentyl, iso-amyl, hexyl, octyl, decyl, and the like.

As used herein “hydroxy” refers to —OH.

As used herein “H” refers to a hydrogen atom.

As used herein “ppm” refers to parts-per-million. It is to be understood that 1 ppm is approximately 1 mg/L and that ppm and mg/L may be used interchangeably.

As used herein, the units “ai/acre” will be understood throughout this disclosure to be an expression of active ingredient per acre.

### DETAILED DESCRIPTION OF PREFERRED EMBODIMENTS

Thaxtomins

Streptomyces scabies, S. acidiscabies, and S. turgidiscabies are the causative agents of scab disease on a variety of underground potato. A class of phytotoxins, thaxtomin, has been identified therefrom which are involved in the pathogenesis. Thaxtomins have been found to have herbicidal and herbistatic activity. It has further been found that thaxtomin activity is enhanced when applied in combination with an herbicide.

Suitable thaxtomins for use in accordance with this disclosure include one or more purified, synthetic, or recombinant thaxtomins, or a combination thereof. Thaxtomins include any of the type from a family of cyclic dipeptides, such as 4-nitroindol-3-yl-containing 2,5-dioxopiperazines commonly known as the thaxtomins. Suitable thaxtomins include agents described as cyclic dipeptides having the basic structure cyclo-(L-4-nitrotryptophyl-L-phenylalanyl. In embodiments, suitable diketopiperazine moieties may be N-methylated, and include congeners carrying phenylalanyl α- and ring-carbon hydroxyl groups. Non-limiting examples of suitable thaxtomins for use in accordance with the present disclosure include thaxtomin A, thaxtomin A ortho isomer, thaxtomin B, and C-14 deoxythaxtomin B (thaxtomin D). Combinations of thaxtomins and derivatives thereof are also suitable for use in accordance with the present disclosure.

In embodiments, purified thaxtomin and analogues thereof are suitable herbicides for use in accordance with the present disclosure. The chemical compositions include:

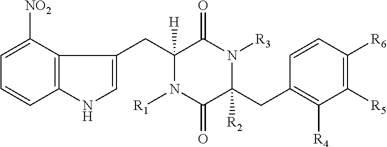

In embodiments, R₁ is methyl or H.

In embodiments, R₂ is hydroxy or H.

In embodiments, R₃ is methyl or H.

In embodiments, R₄ is hydroxy or H.

In embodiments, R₅ is hydroxy or H.

In embodiments, R₆, hydroxy or H.

In embodiments, R₁ is methyl, R₂ is hydroxy, R₃ is methyl, R₄ is H, R₅ is hydroxy and R₆ is H.

In embodiments, R₁ is methyl, R₂ is hydroxy, R₃ is methyl, R₄ is hydroxy, R₅ is H and R₆ is H.

In embodiments, R₁ is methyl, R₂ is H, R₃ is H, R₄ is H, R₅ is H and R₆ is H.

In embodiments, R₁ is methyl, R₂ is hydroxy, R₃ is methyl, R₄ is H, R₅ is H and R₆ is H.

In embodiments, R₁ is methyl, R₂ is H, R₃ is methyl, R₄ is H, R₅ is H and R₆ is H.

In embodiments, R₁ is methyl, R₂ is hydroxy, R₃ is H, R₄ is H, R₅ is H and R₆ is H.

In embodiments, R₁ is methyl, R₂ is hydroxy, R₃ is methyl, R₄ is H, R₅ is H and R₆ is hydroxy.

In embodiments, R₁ is methyl, R₂ is hydroxy, R₃ is methyl, R₄ is H, R₅ is hydroxy and R₆ is hydroxy.

In embodiments, R₁ is methyl, R₂ is hydroxy, R₃ is H, R₄ is H, R₅ is hydroxy and R₆ is H.

In embodiments, R₁ is H, R₂ is hydroxy, R₃ is methyl, R₄ is H, R₅ is hydroxy and R₆ is H.

In embodiments, R₁ is H, R₂ is H, R₃ is H, R₄ is H, R₅ is H and R₆ is H.

In embodiments, purified thaxtomin A is a suitable herbicide for use in accordance with the present disclosure. Thaxtomin A is a yellow compound composed of 4-nitroindol-3-yl-containing 2,5-dioxopiperazine and is the predominant thaxtomin produced by Streptomyces scabies, Streptomyces acidiscabies, and Streptomyces turgidiscabies, with phenylalanyl m-ring and α-C hydroxyl additions. The chemical composition comprises:

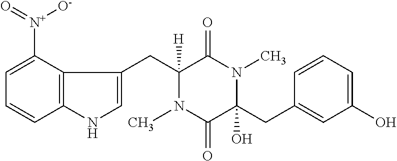 [SMILES: CN1C(=O)[C@](O)(Cc2cccc(O)c2)N(C)C(=O)[C@@H]1Cc1c[nH]c2cccc([N+](=O)[O-])c12]

The mode of action of thaxtomin on weeds is not completely known. However, not wishing to be bound by the present disclosure it is believed thaxtomins when contacted with weeds inhibit cellulose biosynthesis.

In embodiments, unpurified supernatant from cell cultures such as cell cultures of Streptomyces scabies, Streptomyces acidiscabies, and Streptomyces turgidiscabies containing one or more thaxtomin(s) is suitable for use in accordance with the present disclosure. One of ordinary skill in the art would readily envision that supernatant is readily obtainable from cell cultures, such as through centrifugation and collection of the remaining liquid portion.

In embodiments, compositions for use in accordance with the present disclosure contain one or more thaxtomins in an effective amount in combination with one or more herbicides to prevent, reduce or eliminate weed populations. As used herein “effective amount” refers to an amount of a compound or composition having thaxtomin constituents and herbicide constituents, applied together or sequentially, in accordance with the present disclosure, which is sufficient to control weeds (such as prevent weeds, reduce weeds, and/or eliminate weeds) in the treated environment, such as, soil, field, grass, turf and/or aquatic conditions, etc. The positive benefit can be cosmetic in nature, or health-related, or a combination of the two. In embodiments, the positive benefit is achieved by contacting a contaminated environment with a combination of one or more thaxtomins and one or more herbicides, and/or one or more thaxtomin constituents and one or more herbicides, to improve weed control. Treatments include contacting environments populated by weeds with an amount of thaxtomin and one or more herbicides effective to be herbicidal and/or herbistatic.

The particular thaxtomin concentration applied generally depends on the purpose for which the composition is to be applied. For example, the dosage and frequency of application can vary depending upon the type and severity of the weeds populating a particular area and the concentration of the one or more herbicides being used in combination with the thaxtomin. In embodiments, one or more thaxtomins are applied to weeds and/or terrestrial and/or aquatic areas such that the thaxtomin concentration is applied in an amount of about 0.5 ppm to 500 ppm. In embodiments, one or more thaxtomins are applied to weeds and/or terrestrial and/or aquatic areas such that the thaxtomin concentration is in an amount of 1 ppm to 200 ppm. In embodiments, one or more thaxtomins are applied to weeds and/or terrestrial and/or aquatic areas such that the thaxtomin concentration is in an amount of 1 ppm to 100 ppm. In another embodiment, the one or more thaxtomins are applied to weeds and/or terrestrial and/or aquatic areas such that the thaxtomin concentration is in an amount of 25 ppm to 90 ppm. In yet another embodiments, the one or more thaxtomins are applied to weeds and/or terrestrial and/or aquatic areas such that the thaxtomin concentration is in an amount 50 ppm. In yet another embodiments, the one or more thaxtomins are applied to weeds and/or terrestrial and/or aquatic areas such that the thaxtomin concentration is in an amount 77 ppm. In yet another embodiments, the one or more thaxtomins are applied to weeds and/or terrestrial and/or aquatic areas such that the thaxtomin concentration is in an amount 86 ppm.

In embodiments, thaxtomins may be combined with a solvent vehicle to make a formulation for the treatment of weeds in which the major active ingredients are one or more thaxtomins in combination with one or more herbicides. In embodiments, the active ingredients are provided in serums, and aqueous solutions. The amount of thaxtomin mixed with the solvent will vary depending on a number of factors, including, for example, the activity of thaxtomin, the type of thaxtomin selected, the ultimate form of the product and the particular disclosed solvent employed. Solvents useful for preparing the present thaxtomin compositions include any solvent capable solubilizing one or more thaxtomins. Non-limiting examples of such solvents include water and/or aqueous solutions including one or more herbicides.

In embodiments, thaxtomins may be combined with dry excipients to make a formulation for the treatment of weeds in which an ingredient is one or more thaxtomins. In embodiments, the active ingredients are provided in dry form. The thaxtomin constituent will constitute from 1 to 95 weight percent of the thaxtomin dry formulation.

Herbicides

Suitable herbicides for use in accordance with this disclosure include one or chemical herbicides, bioherbicides, organic herbicides, or a combination thereof. More specifically, the one or more herbicides are a pre-plant incorporated herbicide, a pre-emergent herbicide, a post-emergent herbicide, or a combination thereof. Non-limiting examples of suitable herbicides include bentazon, acifluorfen, chlorimuron, lactofen, clomazone, fluazifop, glufosinate, glyphosate, sethoxydim, imazethapyr, imazamox, fomesafe, flumiclorac, imazaquin, clethodim, pendimethalin; 3,4-Dimethyl-2,6-dinitro-N-pentan-3-yl-aniline; N-(1-ethylpropyl)-2,6-dinitro-3,4-xylidine; pronamide; propyzamide; 3,5-Dichloro-N-(1,1-dimethylpropynyl)benzamide; 3,5-Dichloro-N-(1,1-dimethyl-2-propynyl)benzamide; N-(1,1-Dimethylpropynyl)-3,5-dichlorobenzamide; S-ethyl N-ethylthiocyclohexanecarbamate; trifluralin; 2,6-Dinitro-N,N-dipropyl-4-(trifluoromethyl)aniline; glyphosate; N-(phosphonomethyl)glycine; and derivatives thereof. In one embodiment, the one or more herbicides for use in accordance with this disclosure include pronamide (commercially referred to as Kerb®); propyzamide; 3,5-Dichloro-N-(1,1-dimethylpropynyl)benzamide; 3,5-Dichloro-N-(1,1-dimethyl-2-propynyl)benzamide; N-(1,1-Dimethylpropynyl)-3,5-dichlorobenzamide; cycloate, S-ethyl N-ethylthiocyclohexanecarbamate (commercially referred to as Ro-Neet®); trifluralin; 2,6-Dinitro-N,N-dipropyl-4-(trifluoromethyl)aniline; glyphosate; N-(phosphonomethyl)glycine; and derivatives thereof. In an even more particular embodiment, the one or more herbicides for use in accordance with this disclosure include pronamide, cycloate, trifluralin, and combinations thereof. Commercial products containing each of these compounds are readily available.

Herbicide concentration in the composition will generally correspond to the labeled use rate for a particular herbicide. Likewise, the particular herbicide concentration applied generally depends on the purpose for which the composition is to be applied. For example, the dosage and frequency of application can vary depending upon the type and severity of the weeds populating a particular area and the concentration of the one or more thaxtomins used in combination with the herbicide. In embodiments, one or more herbicides are applied to weeds and/or terrestrial and/or aquatic areas such that the herbicide concentration is in an amount of 0.5 ppm to 200 ppm. In another embodiment, one or more herbicides are applied to weeds, and/or terrestrial areas, and/or aquatic areas such that the herbicide concentration is applied in an amount of about 50 ppm to 120 ppm.

Methods

The one or more thaxtomins and one or more herbicides may be used according to the methods provided herein. The methods include applying a predetermined amount of one or more thaxtomins and one or more herbicides to an area and/or environments populated with weeds to control, minimize and/or eliminate undesirable weeds. Non-limiting examples of weeds, as described herein, include grassy, sedge, and broadleaf weeds. In particular, non-limiting examples of weeds as described herein may include weeds from the genera Chenopodium sp., Abutilon sp., Helianthus sp., Ambrosia sp., Amaranthus sp., Convolvulus sp., Brassica sp., Taraxacum sp., Solanum sp., Malva sp., Setaria sp., Bromus tsp., Poa sp., Lolium sp., Festuca sp., Echinochloa sp., Capsella sp., Senecio sp., Cicerbita sp., Sonchus sp., Sinapis sp., Erodium sp., Medicago sp., Uritica sp., Plantago sp., Polygonum sp., Kochia, sp., Cyperus sp., Eleusine sp., Cardamine sp., Portulaca sp., Spergula sp., Ipomoea sp., Matricaria sp., Cerastium sp., Eragnostis sp., Lamium sp., and Trianthema sp. Even more particularly, non-limiting examples of weeds as described herein may include Sinapis arvensis, Common groundsel—Senecio vulgaris, Mallow—Malva sp., Common Mallow—Malva neglecta, Red Stem Filaree—Erodium cictarium, Sow Thistle—Sonchus sp., Shepherd's Purse—Capsella bursa-pastoris, California Burclover—Medicago polymorpha, Western Ragweed—Ambrosia psilostachya, Common Ragweed—Ambrosia artemisiifolia, Burning Nettle—Uritica urens, Buckhorn Plantain—Plantago lanceolata, Knotweed—Polygonum sp., Kochia—Kochia sp., Kochia—Kochia scoparia, Field Bindweed—Convolvulus arvensis, Yellow Nutsedge—Cyperus esculentus, Livid Amaranth—Amaranthus lividus, Redroot Pigweed—Amaranthus retroflexus, Goosegrass—Elusine indica, Small-Flowered Bittercress—Cardamine parviflora, Common Purslane—Portulaca oleracea, Corn Spurry—Spergula arvensis, Hairy Nightshade—Solanum sarrachoides, Ivy-Leaved Morning Glory—Iponoea hederacea, Rayless Mayweed—Matricaria discoidea, Common Lamb's Quarters—Chenopodium album, Chickweed—Cerastium sp., Mexican Lovegrass—Eragnostis Mexicana, Henbit—Lamium amplexicaule, Garden Pigweed—Trianthema decandra, and Common Barnyard Grass—Echinochloa crus-galli.

The one or more thaxtomins and/or one or more herbicides may be in solution and/or solvated and made available to kill, control and/or minimize weeds. In embodiments, the one or more thaxtomins and one or more herbicides are in solution, and therefore available to penetrate the weeds and/or soil to make contact with the weeds in a bio-effective form. In one embodiment, the area in need of control comprises a terrestrial environment or aquatic environment (e.g., an aqueous environment such as salt water environments, fresh water environments, and/or brackish water environments, etc. (e.g., pools, aquariums, ponds, lakes, streams, rivers, creeks, estuaries, tidal basins, bays, oceans, etc.)).

In a particular embodiment, the area in need of control is a terrestrial environment. Non-limiting examples of terrestrial environments include soil environments, grass environments, and/or turf environments. Soil environments, as described herein, generally describe environments wherein the environment is a planting medium that is substantially soil. Non-limiting examples of soil environments may include, but are not meant to be limited by, crop fields (e.g., corn fields, soybean fields, wheat fields, barley fields, triticale fields, rye fields, sorghum fields, sugar cane fields, fruit fields, vegetable fields, potato fields, ornamental flower fields, etc.), home or residential gardens (e.g., ornamental flower gardens, vegetable gardens, fruit gardens, etc.), and greenhouse and/or potted environments. Grass environments, as described herein, may include, but is not intended to be limited by, grassy pastures, lawns, etc. Turf environments, as described herein, may include, but is not intended to be limited by, golf courses, athletic fields, etc.

In an embodiment, the method comprises treating weeds comprising contacting weeds with of one or more thaxtomins in combination with one or more herbicides. In one embodiment, the method of treating weeds controls the growth of weeds. In still another embodiment, the method of treating weeds kills weeds. In still yet another embodiment, the weeds to be treated according to the method are pre-emergent weeds. In a particular embodiment of the method for treating weeds, the one or more herbicides are selected from the group consisting of pronamide, cycloate, trifluralin, and combinations thereof.

According to the method, the one or more thaxtomins may contact the weed before or after the one or more herbicides. In another embodiment, the one or more thaxtomins contact the weed simultaneously with the one or more herbicides (e.g., the one or more thaxtomins and the one or more herbicides are in solution together, the one or more thaxtomins and the one or more herbicides are applied separately but at the same time, etc.). In still another embodiment, the weeds are contacted with one or more thaxtomins as described herein and one or more herbicides before the weeds have emerged from the soil (i.e., pre-emergence). In another embodiment, the weeds are contacted with one or more thaxtomins as described herein and one or more herbicides after the weeds have emerged. In still another embodiment, the weeds are contacted with one or more thaxtomins as described herein and one or more herbicides before and after the weeds have emerged. According to the method, the contacting as described herein may be repeated. In one embodiment, the contacting is repeated daily (e.g., every day or every 24 hours), weekly (e.g., every 7 days or every 168 hours), every 2 weeks, every 4 weeks, every month, every two months, every 3 months, every 4 months, every 5 months, every 6 months, every 7 months, every 8 months, every 9 months, every 10 months, every 11 months, every 12 months, and/or every year. The contacting may occur according to any method known to those skilled in the art (e.g., applying, spraying, drenching, etc.). The combination of the one or more thaxtomins and one or more herbicides are applied until the treatment goals are obtained. However, the duration of the treatment can vary depending on the severity of the condition. For example, treatments can last several days to weeks depending on whether the goal of treatment is to control, reduce, inhibit, and/or eliminate weed populations.

In still another embodiment the method comprises controlling the growth of weeds comprising contacting a soil with one or more thaxtomins and one or more herbicides. In one embodiment, the one or more herbicides are selected from the group consisting of pronamide, cycloate, trifluralin, and combinations thereof. In a particular embodiment, the weeds to be treated are pre-emergent weeds.

According to the method, the one or more thaxtomins may contact the soil before or after the one or more herbicides. In another embodiment, the one or more thaxtomins contact the soil simultaneously with the one or more herbicides (e.g., the one or more thaxtomins and the one or more herbicides are in solution together, the one or more thaxtomins and the one or more herbicides are applied separately but at the same time, etc.). In still another embodiment, the soil is contacted with one or more thaxtomins as described herein and one or more herbicides before the weeds have emerged from the soil (i.e., pre-emergence). In another embodiment, the soil is contacted with one or more thaxtomins as described herein and one or more herbicides after the weeds have emerged. In still another embodiment, the soil is contacted with one or more thaxtomins as described herein and one or more herbicides before and after the weeds have emerged from the soil. According to the method, the contacting as described herein may be repeated. In one embodiment, the contacting is repeated daily (e.g., every day or every 24 hours), weekly (e.g., every 7 days or every 168 hours), every 2 weeks, every 4 weeks, every month, every two months, every 3 months, every 4 months, every 5 months, every 6 months, every 7 months, every 8 months, every 9 months, every 10 months, every 11 months, every 12 months, and/or every year. The contacting may occur according to any method known to those skilled in the art (e.g., applying, spraying, drenching, etc.). The combination of the one or more thaxtomins and one or more herbicides are applied until the treatment goals are obtained. However, the duration of the treatment can vary depending on the severity of the condition. For example, treatments can last several days to weeks depending on whether the goal of treatment is to control, reduce, inhibit, and/or eliminate weed populations.

In another embodiment, the method comprises contacting terrestrial areas containing weeds with one or more thaxtomins in combination with one or more herbicides to improve weed control. In embodiments, areas in need of treatment or weed control such as terrestrial environments, including soil environments, grass environments, and/or turf environments, and/or aquatic environments, are treated by applying to these areas, one or more thaxtomin compositions in combination with one or more herbicides. The combination of the one or more thaxtomins and one or more herbicides are applied until the treatment goals are obtained. However, the duration of the treatment can vary depending on the severity of the condition. For example, treatments can last several days to weeks depending on whether the goal of treatment is to control, reduce, inhibit, and/or eliminate weed populations.

### EXAMPLES

The following non-limiting examples further illustrate compositions, methods, and treatments in accordance with the present disclosure. It should be noted that the disclosure is not limited to the specific details embodied in the examples.

In the Examples and Tables provided infra, weeds will be referred to by their corresponding weed code. Table 1 provides the weed code, common name, and genus/species correspondence for the weeds tested.

TABLE 1
Weed Code, Common Name, and Genus/Species Correspondence.

| Weed Code | Common Name | Genus/Species |
|---|---|---|
| 1. SINAR | Wild Mustard | Sinapis arvensis |
| 2. SENVU | Common groundsel | Senecio vulgaris |
| 3. MALSS | Mallow | Malva sp. |
| 4. MALNE | Common Mallow | Malva neglecta |
| 5. EROCI | Redstem Filaree | Erodium cictarium |
| 6. SONSS | Sow Thistle | Sonchus sp. |
| 7. CAPBP | Shepherd's Purse | Capsella bursa-pastoris |
| 8. MEDPO | California Burclover | Medicago polymorpha |
| 9. AMBPS | Western Ragweed | Ambrosia psilostachya |
| 10. AMBEL | Common Ragweed | Ambrosia artemisiifolia |
| 11. URTUR | Burning Nettle | Uritica urens |
| 12. PLALA | Buckhorn Plantain | Plantago lanceolata |
| 13. POLSS | Knotweed | Polygonum sp. |
| 14. KCHSS | Kochia | Kochia sp. |
| 15. KCHSC | Kochia | Kochia scoparia |
| 16. CONAR | Field Bindweed | Convolvulus arvensis |
| 17. CYPES | Yellow Nutsedge | Cyperus esculentus |
| 18. AMALI | Livid Amaranth | Amaranthus lividus |
| 19. AMARE | Redroot Pigweed | Amaranthus retroflexus |
| 20. ELEIN | Goosegrass | Elusine indica |
| 21. CARPA | Small-Flowered Bittercress | Cardamine parviflora |
| 22. POROL | Common Purslane | Portulaca oleracea |
| 23. SPRAR | Corn Spurry | Spergula arvensis |
| 24. SOLSA | Hairy Nightshade | Solanum sarrachoides |
| 25. IPOHE | Ivy-Leaved Morning Glory | Iponoea hederacea |
| 26. MATMT | Rayless Mayweed | Matricaria discoidea |
| 27. CHEAL | Common Lamb's Quarters | Chenopodium album |
| 28. CERSS | Chickweed | Cerastium sp. |
| 29. ERAMX | Mexican Lovegrass | Eragnostis Mexicana |
| 30. LMAM | Henbit | Lamium amplexicaule |
| 31. TRTDE | Garden Pigweed | Thanthema decandra |
| 32. ECHCG | Common Barnyard Grass | Echinochloa crus-galli |

### Example 1

This study was conducted to evaluate the efficacy of a thaxtomin bioherbicide alone and in combination with Kerb® for control of broadleaf weed species in seeded lettuce along the Central California Coast. This study consisted of eight (8) treatments applied to a soil surface at a single application time (i.e., “Time A”).

Treatment applications were performed using a CO₂ backpack sprayer with a spray boom incorporating 2 XR TeeJet® flat spray nozzles at 40 psi directed at the soil surface. Water incorporation was applied to the randomized plots by an 8 nozzle water boom.

The following treatments were applied and correspond to Tables 2-15:
Treatment 1. Untreated check/control (designated as “--”);
Treatment 2. Thaxtomin at 50 mg/L applied as a spray at a rate of 100 g ai/acre;
Treatment 3. Thaxtomin at 50 mg/L applied as a spray at a rate of 150 g ai/acre;
Treatment 4. Thaxtomin at 50 mg/L applied as a spray at a rate of 200 g ai/acre;
Treatment 5. Kerb® applied as a spray at a rate of 4.0 lb/acre;
Treatment 6. Thaxtomin at 50 mg/L applied as a spray at a rate of 100 g ai/acre in combination with Kerb® applied as a spray at 3.0 lb/acre;
Treatment 7. Thaxtomin at 50 mg/L applied as a spray at a rate of 150 g ai/acre in combination with Kerb® applied as a spray at 2.0 lb/acre; and
Treatment 8. Thaxtomin at 50 mg/L applied as a spray at a rate of 200 g ai/acre in combination with Kerb® applied as a spray at 1.0 lb/acre.
   Results are provided in Tables 2-15.

TABLE 2.
Weed Count. Average broadleaf weed counts listed by species per
treatment at 2 weeks.

| Trt. No. | Rate | | Time | SINAR | | SENVU | | MALSS | | EROCI | | SONSS | |
|---|---|---|---|---|---|---|---|---|---|---|---|---|---|
| 1 | — | | — | 141.75 | a | 188.75 | a | 18.00 | a | 7.50 | a | 18.00 | a |
| 2 | 100 | g ai/a | A | 3.50 | c | 5.25 | c | 0.75 | b | 0.00 | b | 0.00 | c |
| 3 | 150 | g ai/a | A | 0.75 | c | 0.00 | c | 0.00 | b | 0.00 | b | 0.00 | c |
| 4 | 200 | g ai/a | A | 0.25 | c | 0.00 | c | 0.00 | b | 0.00 | b | 0.00 | c |
| 5 | 4.0 | lb/a | A | 36.50 | b | 83.50 | b | 6.75 | b | 1.25 | b | 11.75 | b |
| 6 | 100 | g ai/a | A | 0.50 | c | 0.00 | c | 0.50 | b | 0.00 | b | 0.00 | c |
| | 3.0 | lb/a | | | | | | | | | | | |
| 7 | 150 | g ai/a | A | 0.00 | c | 0.00 | c | 0.00 | b | 0.00 | b | 0.00 | c |
| | 2.0 | lb/a | | | | | | | | | | | |
| 8 | 200 | g ai/a | A | 0.25 | c | 0.25 | c | 0.00 | b | 0.00 | b | 0.00 | c |
| | 1.0 | lb/a | | | | | | | | | | | |

Time “A” indicates application of treatments to the soil surface before the weed(s) has emerged.

TABLE 3
Percent Control. Average percent control of broadleaf weeds listed by
species per treatment at 2 weeks.

| Trt. No. | Rate | | Time | SINAR | SENVU | MALSS | EROCI | SONSS |
|---|---|---|---|---|---|---|---|---|
| 1 | — | | — | 0.00 | 0.00 | 0.00 | 0.00 | 0.00 |
| 2 | 100 | g ai/a | A | 97.53 | 97.22 | 95.83 | 100.00 | 100.00 |
| 3 | 150 | g ai/a | A | 99.47 | 100.00 | 100.00 | 100.00 | 100.00 |
| 4 | 200 | g ai/a | A | 99.82 | 100.00 | 100.00 | 100.00 | 100.00 |
| 5 | 4.0 | lb/a | A | 74.25 | 55.76 | 62.50 | 83.33 | 34.72 |
| 6 | 100 | g ai/a | A | 99.65 | 100.00 | 97.22 | 100.00 | 100.00 |
| | 3.0 | lb/a | | | | | | |
| 7 | 150 | g ai/a | A | 100.00 | 100.00 | 100.00 | 100.00 | 100.00 |
| | 2.0 | lb/a | | | | | | |
| 8 | 200 | g ai/a | A | 99.82 | 99.87 | 100.00 | 100.00 | 100.00 |
| | 1.0 | lb/a | | | | | | |

Timings for Table 3 are the same as those for Table 2.

TABLE 4
Weed Count. Average broadleaf weed counts listed by species per treatment at
4 weeks.

| Trt. | | | | | | | | | | | | | |
|---|---|---|---|---|---|---|---|---|---|---|---|---|---|
| No. | Rate | | Time | SINAR | | SENVU | | MALSS | | EROCI | | SONSS | |
| 1 | — | | — | 187.50 | a | 270.25 | a | 24.00 | a | 11.75 | a | 33.00 | a |
| 2 | 100 | g ai/a | A | 18.75 | c | 5.25 | c | 1.75 | b | 0.00 | b | 0.25 | c |
| 3 | 150 | g ai/a | A | 12.25 | c | 0.00 | c | 0.50 | b | 0.25 | b | 0.00 | c |
| 4 | 200 | g ai/a | A | 6.75 | c | 0.00 | c | 1.00 | b | 0.25 | b | 0.25 | c |
| 5 | 4.0 | lb/a | A | 39.25 | b | 145.25 | b | 8.00 | b | 1.50 | b | 18.50 | b |
| 6 | 100 | g ai/a | A | 4.00 | c | 0.25 | c | 1.75 | b | 0.00 | b | 0.25 | c |
| | 3.0 | lb/a | | | | | | | | | | | |
| 7 | 150 | g ai/a | A | 3.00 | c | 0.00 | c | 0.75 | b | 0.00 | b | 0.25 | c |
| | 2.0 | lb/a | | | | | | | | | | | |
| 8 | 200 | g ai/a | A | 3.25 | c | 0.25 | c | 0.00 | b | 0.00 | b | 0.00 | c |
| | 1.0 | lb/a | | | | | | | | | | | |

| Trt. | | | | | | | | | | | |
|---|---|---|---|---|---|---|---|---|---|---|---|
| No. | Rate | | Time | CAPBP | | MEDPO | | AMBPS | | URTUR | |
| 1 | — | | — | 136.75 | a | 9.00 | a | 3.75 | a | 9.00 | a |
| 2 | 100 | g ai/a | A | 0.00 | b | 0.50 | b | 0.00 | b | 0.00 | b |
| 3 | 150 | g ai/a | A | 2.75 | b | 1.50 | b | 0.00 | b | 0.00 | b |
| 4 | 200 | g ai/a | A | 0.00 | b | 0.25 | b | 0.00 | b | 0.00 | b |
| 5 | 4.0 | lb/a | A | 0.75 | b | 2.00 | b | 1.50 | b | 0.00 | b |
| 6 | 100 | g ai/a | A | 0.50 | b | 3.00 | b | 0.00 | b | 0.25 | b |
| | 3.0 | lb/a | | | | | | | | | |
| 7 | 150 | g ai/a | A | 0.00 | b | 1.25 | b | 0.00 | b | 0.00 | b |
| | 2.0 | lb/a | | | | | | | | | |
| 8 | 200 | g ai/a | A | 0.00 | b | 0.25 | b | 0.00 | b | 0.00 | b |
| | 1.0 | lb/a | | | | | | | | | |

Timings for Table 4 are the same as those for Table 2.

TABLE 5
Percent Control. Average percent control of broadleaf weeds listed by species
per treatment at 4 weeks.

| Trt. | | | | | | | | |
|---|---|---|---|---|---|---|---|---|
| No. | Rate | | Time | SINAR | SENVU | MALSS | EROCI | SONSS |
| 1 | — | | — | 0.00 | 0.00 | 0.00 | 0.00 | 0.00 |
| 2 | 100 | g ai/a | A | 90.00 | 98.06 | 92.71 | 100.00 | 99.24 |
| 3 | 150 | g ai/a | A | 93.47 | 100.00 | 97.92 | 97.87 | 100.00 |
| 4 | 200 | g ai/a | A | 96.40 | 100.00 | 95.83 | 97.87 | 99.24 |
| 5 | 4.0 | lb/a | A | 79.07 | 46.25 | 66.67 | 87.23 | 43.94 |
| 6 | 100 | g ai/a | A | 97.87 | 99.91 | 92.71 | 100.00 | 99.24 |
| | 3.0 | lb/a | | | | | | |
| 7 | 150 | g ai/a | A | 98.40 | 100.00 | 96.88 | 100.00 | 99.24 |
| | 2.0 | lb/a | | | | | | |
| 8 | 200 | g ai/a | A | 98.27 | 99.91 | 100.00 | 100.00 | 100.00 |
| | 1.0 | lb/a | | | | | | |

| Trt. | | | | | | | |
|---|---|---|---|---|---|---|---|
| No. | Rate | | Time | CAPBP | MEDPO | AMBPS | URTUR |
| 1 | — | | — | 0.00 | 0.00 | 0.00 | 0.00 |
| 2 | 100 | g ai/a | A | 100.00 | 94.44 | 100.00 | 100.00 |
| 3 | 150 | g ai/a | A | 97.99 | 83.33 | 100.00 | 100.00 |
| 4 | 200 | g ai/a | A | 100.00 | 97.22 | 100.00 | 100.00 |
| 5 | 4.0 | lb/a | A | 99.45 | 77.78 | 60.00 | 100.00 |
| 6 | 100 | g ai/a | A | 99.63 | 66.67 | 100.00 | 97.22 |
| | 3.0 | lb/a | | | | | |
| 7 | 150 | g ai/a | A | 100.00 | 86.11 | 100.00 | 100.00 |
| | 2.0 | lb/a | | | | | |
| 8 | 200 | g ai/a | A | 100.00 | 97.22 | 100.00 | 100.00 |
| | 1.0 | lb/a | | | | | |

Timings for Table 5 are the same as those for Table 2.

TABLE 6
Weed Count. Average broadleaf weed counts listed by species per treatment at
6 weeks.

| Trt. No. | Rate | | Time | SINAR | | SENVU | | MALSS | | EROCI | | SONSS | |
|---|---|---|---|---|---|---|---|---|---|---|---|---|---|
| 1 | — | | — | 193.25 | a | 287.50 | a | 25.25 | a | 12.00 | a | 34.75 | a |
| 2 | 100 | g ai/a | A | 21.25 | bc | 5.25 | c | 2.75 | b | 0.00 | b | 0.50 | c |
| 3 | 150 | g ai/a | A | 13.75 | c | 0.00 | c | 1.25 | b | 0.50 | b | 0.00 | c |
| 4 | 200 | g ai/a | A | 7.75 | c | 0.00 | c | 1.00 | b | 0.25 | b | 0.25 | c |
| 5 | 4.0 | lb/a | A | 39.25 | b | 155.75 | b | 8.75 | b | 1.50 | b | 19.25 | b |
| 6 | 100 | g ai/a | A | 5.00 | c | 0.25 | c | 2.50 | b | 0.00 | b | 0.50 | c |
| | 3.0 | lb/a | | | | | | | | | | | |
| 7 | 150 | g ai/a | A | 4.25 | c | 0.00 | c | 0.75 | b | 0.00 | b | 0.25 | c |
| | 2.0 | lb/a | | | | | | | | | | | |
| 8 | 200 | g ai/a | A | 6.00 | c | 0.25 | c | 0.00 | b | 0.00 | b | 0.00 | c |

| | 1.0 | lb/a | | | | | | | | | |
|---|---|---|---|---|---|---|---|---|---|---|---|
| Trt. No. | Rate | | Time | CAPBP | | MEDPO | | AMBPS | URTUR | | PLALA |
| 1 | — | | — | 162.25 | a | 18.00 | a | 5.25 a | 40.00 | a | 3.50 a |
| 2 | 100 | g ai/a | A | 1.75 | b | 2.50 | b | 0.00 c | 2.00 | b | 1.00 b |
| 3 | 150 | g ai/a | A | 3.50 | b | 1.75 | b | 0.00 c | 0.25 | b | 0.75 b |
| 4 | 200 | g ai/a | A | 0.75 | b | 0.50 | b | 0.00 c | 0.00 | b | 0.25 b |
| 5 | 4.0 | lb/a | A | 7.25 | b | 4.50 | b | 2.75 b | 1.00 | b | 0.00 b |
| 6 | 100 | g ai/a | A | 2.50 | b | 3.75 | b | 0.00 c | 0.75 | b | 0.00 b |
| | 3.0 | lb/a | | | | | | | | | |
| 7 | 150 | g ai/a | A | 0.00 | b | 1.25 | b | 0.00 c | 0.50 | b | 0.00 b |
| | 2.0 | lb/a | | | | | | | | | |
| 8 | 200 | g ai/a | A | 0.00 | b | 0.25 | b | 0.00 c | 0.00 | b | 0.25 b |

| | |
|---|---|
| 1.0 | lb/a |

Timings for Table 6 are the same as those for Table 2.

TABLE 7
Percent Control. Average percent control of broadleaf weeds listed by species per treatment at 6 weeks.

| Trt. No. | Rate | | Time | SINAR | SENVU | MALSS | EROCI | SONSS |
|---|---|---|---|---|---|---|---|---|
| 1 | — | | — | 0.00 | 0.00 | 0.00 | 0.00 | 0.00 |
| 2 | 100 | g ai/a | A | 89.00 | 98.17 | 89.11 | 100.00 | 98.56 |
| 3 | 150 | g ai/a | A | 92.88 | 100.00 | 95305 | 95.83 | 100.00 |
| 4 | 200 | g ai/a | A | 95.99 | 100.00 | 96.04 | 97.92 | 99.28 |
| 5 | 4.0 | lb/a | A | 79.69 | 45.83 | 65.35 | 87.50 | 44.60 |
| 6 | 100 | g ai/a | A | 97.41 | 99.91 | 90.10 | 100.00 | 98.56 |
| | 3.0 | lb/a | | | | | | |
| 7 | 150 | g ai/a | A | 97.80 | 100.00 | 97.03 | 100.00 | 99.28 |
| | 2.0 | lb/a | | | | | | |
| 8 | 200 | g ai/a | A | 96.90 | 99.91 | 100.00 | 100.00 | 100.00 |
| | 1.0 | lb/a | | | | | | |
| Trt. No. | Rate | | Time | CAPBP | MEDPO | AMBPS | URTUR | PLALA |
| 1 | — | | — | 0.00 | 0.00 | 0.00 | 0.00 | 0.00 |
| 2 | 100 | g ai/a | A | 98.92 | 86.11 | 100.00 | 95.00 | 71.43 |
| 3 | 150 | g ai/a | A | 97.84 | 90.28 | 100.00 | 99.38 | 78.57 |
| 4 | 200 | g ai/a | A | 99.54 | 97.22 | 100.00 | 100.00 | 92.86 |
| 5 | 4.0 | lb/a | A | 95.53 | 75.00 | 47.62 | 97.50 | 100.00 |
| 6 | 100 | g ai/a | A | 98.46 | 79.17 | 100.00 | 98.13 | 100.00 |
| | 3.0 | lb/a | | | | | | |
| 7 | 150 | g ai/a | A | 100.00 | 93.06 | 100.00 | 98.75 | 100.00 |
| | 2.0 | lb/a | | | | | | |
| 8 | 200 | g ai/a | A | 100.00 | 98.61 | 100.00 | 100.00 | 92.86 |
| | 1.0 | lb/a | | | | | | |

Timings for Table 7 are the same as those for Table 2.

TABLE 8
Weed Count. Average broadleaf weed counts listed by species per treatment at
10 weeks.

| Trt. No. | Rate | | Time | SINAR | | SENVU | | MALSS | | EROCI | | SONSS | | CAPBP | |
|---|---|---|---|---|---|---|---|---|---|---|---|---|---|---|---|
| 1 | — | | — | 201.25 | a | 301.00 | a | 28.25 | a | 17.00 | a | 38.75 | a | 179.00 | a |
| 2 | 100 | g ai/a | A | 25.25 | bc | 9.75 | c | 5.75 | b | 1.00 | b | 1.75 | c | 10.50 | b |
| 3 | 150 | g ai/a | A | 16.00 | bc | 1.25 | c | 3.50 | b | 1.25 | b | 1.75 | c | 9.00 | b |
| 4 | 200 | g ai/a | A | 9.50 | c | 0.50 | c | 2.00 | b | 1.00 | b | 1.25 | c | 5.00 | b |
| 5 | 4.0 | lb/a | A | 40.50 | b | 162.25 | b | 11.00 | b | 3.50 | b | 22.50 | b | 16.75 | b |
| 6 | 100 | g ai/a | A | 6.75 | c | 4.00 | c | 5.00 | b | 1.25 | b | 2.50 | c | 9.50 | b |
| | 3.0 | lb/a | | | | | | | | | | | | | |
| 7 | 150 | g ai/a | A | 6.75 | c | 1.75 | c | 3.25 | b | 1.75 | b | 1.00 | c | 3.50 | b |
| | 2.0 | lb/a | | | | | | | | | | | | | |
| 8 | 200 | g ai/a | A | 9.25 | c | 1.00 | c | 2.00 | b | 0.50 | b | 1.25 | c | 2.25 | b |

| | |
|---|---|
| 1.0 | lb/a |

| Trt. No. | Rate | | Time | MEDPO | AMBPS | URTUR | PLALA | POLSS |
|---|---|---|---|---|---|---|---|---|
| 1 | — | | — | 28.50 a | 12.00 a | 57.50 a | 18.25 a | 8.00 a |
| 2 | 100 | g ai/a | A | 8.75 b | 3.25 c | 7.50 b | 6.75 b | 3.25 bc |
| 3 | 150 | g ai/a | A | 5.25 b | 2.50 c | 2.75 b | 6.75 b | 5.00 b |
| 4 | 200 | g ai/a | A | 5.00 b | 1.25 c | 2.50 b | 2.25 c | 1.75 c |
| 5 | 4.0 | lb/a | A | 6.50 b | 8.00 b | 4.00 b | 0.00 c | 2.00 c |
| 6 | 100 | g ai/a | A | 7.00 b | 3.25 c | 5.00 b | 1.00 c | 1.50 c |
| | 3.0 | lb/a | | | | | | |
| 7 | 150 | g ai/a | A | 6.00 b | 1.75 c | 2.50 b | 0.25 c | 2.75 bc |
| | 2.0 | lb/a | | | | | | |
| 8 | 200 | g ai/a | A | 2.50 b | 1.00 c | 1.75 b | 0.25 c | 1.75 c |
| | 1.0 | lb/a | | | | | | |

Timings for Table 8 are the same as those for Table 2.

TABLE 9
Percent Control. Average percent control of broadleaf weeds listed by species per treatment at 10 weeks.

| Trt. No. | Rate | | Time | SINAR | SENVU | MALSS | EROCI | SONSS |
|---|---|---|---|---|---|---|---|---|
| 1 | — | | — | 0.00 | 0.00 | 0.00 | 0.00 | 0.00 |
| 2 | 100 | g ai/a | A | 87.45 | 96.76 | 79.65 | 94.12 | 95.48 |
| 3 | 150 | g ai/a | A | 92.05 | 99.58 | 87.61 | 92.65 | 95.48 |
| 4 | 200 | g ai/a | A | 95.28 | 99.83 | 92.92 | 94.12 | 96.77 |
| 5 | 4.0 | lb/a | A | 79.88 | 46.10 | 61.06 | 79.41 | 41.94 |
| 6 | 100 | g ai/a | A | 96.65 | 98.67 | 82.30 | 92.65 | 93.55 |
| | 3.0 | lb/a | | | | | | |
| 7 | 150 | g ai/a | A | 96.65 | 99.42 | 88.50 | 89.71 | 97.42 |
| | 2.0 | lb/a | | | | | | |
| 8 | 200 | g ai/a | A | 95.40 | 99.67 | 92.92 | 97.06 | 96.77 |
| | 1.0 | lb/a | | | | | | |

| Trt. No. | Rate | | Time | CAPBP | MEDPO | AMBPS | URTUR | PLALA | POLSS |
|---|---|---|---|---|---|---|---|---|---|
| 1 | — | | — | 0.00 | 0.00 | 0.00 | 0.00 | 0.00 | 0.00 |
| 2 | 100 | g ai/a | A | 94.13 | 69.30 | 72.92 | 86.96 | 63.01 | 59.38 |
| 3 | 150 | g ai/a | A | 94.97 | 81.58 | 79.17 | 95.22 | 63.01 | 37.50 |
| 4 | 200 | g ai/a | A | 97.21 | 82.46 | 89.58 | 95.65 | 87.67 | 78.13 |
| 5 | 4.0 | lb/a | A | 90.64 | 77.19 | 33.33 | 93.04 | 100.00 | 75.00 |
| 6 | 100 | g ai/a | A | 94.69 | 75.44 | 72.92 | 91.30 | 94.52 | 81.25 |
| | 3.0 | lb/a | | | | | | | |
| 7 | 150 | g ai/a | A | 98.04 | 78.95 | 85.42 | 95.65 | 98.63 | 65.63 |
| | 2.0 | lb/a | | | | | | | |
| 8 | 200 | g ai/a | A | 98.74 | 91.23 | 91.67 | 96.96 | 98.63 | 78.13 |
| | 1.0 | lb/a | | | | | | | |

Timings for Table 9 are the same as those for Table 2.

TABLE 10
Weed Count. Average broadleaf weed counts listed by species per treatment at
14 weeks.

| Trt. No. | Rate | | Time | SINAR | | SENVU | | MALSS | | EROCI | | SONSS | | CAPBP | |
|---|---|---|---|---|---|---|---|---|---|---|---|---|---|---|---|
| 1 | — | | — | 204.00 | a | 309.75 | a | 30.25 | a | 19.25 | a | 41.25 | a | 191.75 | a |
| 2 | 100 | g ai/a | A | 30.25 | bc | 13.50 | c | 6.75 | b | 1.50 | b | 4.00 | c | 18.00 | b |
| 3 | 150 | g ai/a | A | 20.00 | bc | 3.00 | c | 3.50 | b | 1.50 | b | 3.25 | c | 11.25 | b |
| 4 | 200 | g ai/a | A | 11.25 | c | 2.75 | c | 2.75 | b | 1.75 | b | 1.50 | c | 8.25 | b |
| 5 | 4.0 | lb/a | A | 41.25 | b | 170.75 | b | 12.00 | b | 4.25 | b | 25.25 | b | 23.50 | b |
| 6 | 100 | g ai/a | A | 7.50 | c | 8.25 | c | 6.50 | b | 1.75 | b | 4.25 | c | 17.75 | b |
| | 3.0 | lb/a | | | | | | | | | | | | | |
| 7 | 150 | g ai/a | A | 7.25 | c | 4.25 | c | 3.75 | b | 2.75 | b | 1.50 | c | 6.25 | b |
| | 2.0 | lb/a | | | | | | | | | | | | | |
| 8 | 200 | g ai/a | A | 11.25 | c | 2.75 | c | 2.225 | b | 0.50 | b | 2.25 | c | 5.00 | b |

| | |
|---|---|
| 1.0 | lb/a |

| Trt. No. | Rate | | Time | MEDPO | AMBPS | URTUR | PLALA | POLSS |
|---|---|---|---|---|---|---|---|---|
| 1 | — | | — | 37.75 a | 14.25 a | 71.75 a | 24.25 a | 15.75 a |
| 2 | 100 | g ai/a | A | 12.75 b | 4.25 bc | 13.25 b | 11.25 b | 7.75 b |
| 3 | 150 | g ai/a | A | 10.00 b | 4.00 bc | 8.25 b | 10.00 b | 7.50 b |
| 4 | 200 | g ai/a | A | 7.75 b | 2.00 c | 5.50 b | 5.00 c | 4.25 b |
| 5 | 4.0 | lb/a | A | 11.25 b | 11.25 a | 6.75 b | 1.75 c | 9.00 b |
| 6 | 100 | g ai/a | A | 10.00 b | 7.00 b | 8.75 b | 3.00 c | 5.50 b |
| | 3.0 | lb/a | | | | | | |
| 7 | 150 | g ai/a | A | 8.75 b | 2.50 c | 5.75 b | 2.25 c | 4.50 b |
| | 2.0 | lb/a | | | | | | |
| 8 | 200 | g ai/a | A | 4.00 b | 1.75 c | 4.25 b | 1.50 c | 4.75 b |
| | 1.0 | lb/a | | | | | | |

Timings for Table 10 are the same as those for Table 2.

TABLE 11
Percent Control. Average percent control of broadleaf weeds listed by species per treatment at 14 weeks.

| Trt. No. | Rate | | Time | SINAR | SENVU | MALSS | EROCI | SONSS | CAPBP |
|---|---|---|---|---|---|---|---|---|---|
| 1 | — | | — | 0.00 | 0.00 | 0.00 | 0.00 | 0.00 | 0.00 |
| 2 | 100 | g ai/a | A | 85.17 | 95.64 | 77.69 | 92.21 | 90.30 | 90.61 |
| 3 | 150 | g ai/a | A | 90.20 | 99.03 | 88.43 | 92.21 | 92.12 | 94.13 |
| 4 | 200 | g ai/a | A | 94.49 | 99.11 | 90.91 | 90.91 | 96.36 | 95.70 |
| 5 | 4.0 | lb/a | A | 79.78 | 44.87 | 60.33 | 77.92 | 38.79 | 87.74 |
| 6 | 100 | g ai/a | A | 96.38 | 97.34 | 78.51 | 90.91 | 89.70 | 90.74 |
| | 3.0 | lb/a | | | | | | | |
| 7 | 150 | g ai/a | A | 96.45 | 98.63 | 87.60 | 85.71 | 96.36 | 96.74 |
| | 2.0 | lb/a | | | | | | | |
| 8 | 200 | g ai/a | A | 94.49 | 99.11 | 92.56 | 97.40 | 94.55 | 97.39 |
| | 1.0 | lb/a | | | | | | | |

| Trt. No. | Rate | | Time | MEDPO | AMBPS | URTUR | PLALA | POLSS |
|---|---|---|---|---|---|---|---|---|
| 1 | — | | — | 0.00 | 0.00 | 0.00 | 0.00 | 0.00 |
| 2 | 100 | g ai/a | A | 66.23 | 70.18 | 81.53 | 53.61 | 50.79 |
| 3 | 150 | g ai/a | A | 73.51 | 71.93 | 88.50 | 58.76 | 52.38 |
| 4 | 200 | g ai/a | A | 79.47 | 85.96 | 92.33 | 79.38 | 73.02 |
| 5 | 4.0 | lb/a | A | 70.20 | 21.05 | 90.59 | 92.78 | 42.86 |
| 6 | 100 | g ai/a | A | 73.51 | 50.88 | 87.80 | 87.63 | 65.08 |
| | 3.0 | lb/a | | | | | | |
| 7 | 150 | g ai/a | A | 76.82 | 82.46 | 91.99 | 90.72 | 71.43 |
| | 2.0 | lb/a | | | | | | |
| 8 | 200 | g ai/a | A | 89.40 | 87.72 | 94.08 | 93.81 | 69.84 |
| | 1.0 | lb/a | | | | | | |

Timings for Table 11 are the same as those for Table 2.

TABLE 12
Weed Count. Average broadleaf weed counts listed by species per treatment
at 20 weeks.

| Trt. No. | Rate | | Time | SINAR | SENVU | MALSS | EROCI | SONSS | CAPBP | MEDPO |
|---|---|---|---|---|---|---|---|---|---|---|
| 1 | — | | — | 204.75 a | 311.00 a | 30.50 a | 19.50 a | 41.50 a | 192.25 a | 41.50 a |
| 2 | 100 | g ai/a | A | 31.75 bc | 14.25 c | 7.75 b | 2.25 b | 4.25 c | 18.50 b | 14.50 b |
| 3 | 150 | g ai/a | A | 21.25 bc | 3.25 c | 4.00 b | 1.75 b | 3.50 c | 12.75 b | 11.50 b |
| 4 | 200 | g ai/a | A | 11.25 bc | 3.50 c | 3.00 b | 1.75 b | 1.50 c | 8.50 b | 8.50 b |
| 5 | 4.0 | lb/a | A | 41.25 b | 172.50 b | 13.00 b | 4.25 b | 25.50 b | 25.00 b | 13.75 b |
| 6 | 100 | g ai/a | A | 8.00 c | 8.75 c | 7.00 b | 1.75 b | 4.25 c | 19.75 b | 11.00 b |
| | 3.0 | lb/a | | | | | | | | |
| 7 | 150 | g ai/a | A | 7.25 c | 4.75 c | 4.50 b | 2.75 b | 2.00 c | 6.25 b | 10.00 b |
| | 2.0 | lb/a | | | | | | | | |
| 8 | 200 | g ai/a | A | 11.50 c | 2.75 c | 2.25 b | 0.50 b | 2.25 c | 5.50 b | 4.25 b |
| | 1.0 | lb/a | | | | | | | | |

| Trt. No. | Rate | | Time | AMBPS | URTUR | PLALA | POLSS | KCHSS | CONAR |
|---|---|---|---|---|---|---|---|---|---|
| 1 | — | | — | 15.75 a | 77.50 a | 27.50 a | 18.25 a | 1.00 a | 2.25 a |
| 2 | 100 | g ai/a | A | 5.25 cd | 16.75 b | 13.25 b | 8.50 b | 0.50 a | 2.50 a |
| 3 | 150 | g ai/a | A | 4.00 cd | 9.75 b | 12.00 b | 8.50 b | 0.25 a | 2.50 a |
| 4 | 200 | g ai/a | A | 2.00 d | 7.00 c | 6.00 c | 4.25 b | 0.25 a | 1.50 a |
| 5 | 4.0 | lb/a | A | 12.00 b | 8.00 c | 1.75 c | 9.25 b | 1.00 a | 1.25 a |
| 6 | 100 | g ai/a | A | 7.50 c | 10.00 c | 3.00 c | 5.75 b | 1.00 a | 2.00 a |
| | 3.0 | lb/a | | | | | | | |
| 7 | 150 | g ai/a | A | 3.50 cd | 7.75 c | 2.25 c | 5.50 b | 0.75 a | 1.25 a |
| | 2.0 | lb/a | | | | | | | |
| 8 | 200 | g ai/a | A | 1.75 d | 5.75 c | 1.75 c | 5.25 b | 0.00 a | 0.50 a |
| | 1.0 | lb/a | | | | | | | |

Timings for Table 12 are the same as those for Table 2.

TABLE 13
Percent Control. Average percent control of broadleaf weeds listed by species
per treatment at 20 weeks.

| Trt. No. | Rate | | Time | SINAR | SENVU | MALSS | EROCI | SONSS | CAPBP | MEDPO |
|---|---|---|---|---|---|---|---|---|---|---|
| 1 | — | | — | 0.00 | 0.00 | 0.00 | 0.00 | 0.00 | 0.00 | 0.00 |
| 2 | 100 | g ai/a | A | 84.49 | 95.42 | 74.59 | 88.46 | 89.76 | 90.38 | 65.06 |
| 3 | 150 | g ai/a | A | 89.62 | 98.95 | 86.89 | 91.03 | 91.57 | 93.37 | 72.29 |
| 4 | 200 | g ai/a | A | 94.51 | 98.87 | 90.16 | 91.03 | 96.39 | 95.58 | 79.52 |
| 5 | 4.0 | lb/a | A | 79.85 | 44.53 | 57.38 | 78.21 | 38.55 | 87.00 | 66.87 |
| 6 | 100 | g ai/a | A | 96.09 | 97.19 | 77.05 | 1.03 | 89.76 | 89.73 | 73.49 |
| | 3.0 | lb/a | | | | | | | | |
| 7 | 150 | g ai/a | A | 96.46 | 98.47 | 85.25 | 85.90 | 95.18 | 96.75 | 75.90 |
| | 2.0 | lb/a | | | | | | | | |
| 8 | 200 | g ai/a | A | 94.38 | 99.12 | 92.62 | 97.44 | 94.58 | 97.14 | 89.76 |
| | 1.0 | lb/a | | | | | | | | |

| Trt. No. | Rate | | Time | AMBPS | URTUR | PLALA | POLSS | KCHSS | CONAR |
|---|---|---|---|---|---|---|---|---|---|
| 1 | — | | — | 0.00 | 0.00 | 0.00 | 0.00 | 0.00 | 0.00 |
| 2 | 100 | g ai/a | A | 66.67 | 78.39 | 51.82 | 53.42 | 50.00 | 0.00 |
| 3 | 150 | g ai/a | A | 74.60 | 87.42 | 56.36 | 53.42 | 75.00 | 0.00 |
| 4 | 200 | g ai/a | A | 87.30 | 90.97 | 78.18 | 76.71 | 75.00 | 33.33 |
| 5 | 4.0 | lb/a | A | 23.81 | 89.68 | 93.64 | 49.32 | 0.00 | 44.44 |
| 6 | 100 | g ai/a | A | 52.38 | 87.10 | 89.09 | 68.49 | 0.00 | 11.11 |
| | 3.0 | lb/a | | | | | | | |
| 7 | 150 | g ai/a | A | 77.78 | 90.00 | 91.82 | 69.86 | 25.00 | 44.44 |
| | 2.0 | lb/a | | | | | | | |
| 8 | 200 | g ai/a | A | 88.89 | 92.58 | 93.64 | 71.23 | 100.00 | 77.78 |
| | 1.0 | lb/a | | | | | | | |

Timings for Table 13 are the same as those for Table 2.

TABLE 14
Total Weed Count. Average total broadleaf weed count listed by date per
treatment.

| Trt. No. | Rate | | Time | Week 2 | | Week 4 | | Week 6 | | Week 10 | | Week 14 | | Week 20 | |
|---|---|---|---|---|---|---|---|---|---|---|---|---|---|---|---|
| 1 | — | | — | 374.00 | a | 685.00 | a | 793.75 | a | 889.50 | a | 960.00 | a | 983.25 | a |
| 2 | 100 | g ai/a | A | 9.50 | c | 26.50 | c | 37.00 | c | 83.50 | c | 123.25 | c | 140.00 | c |
| 3 | 150 | g ai/a | A | 0.75 | c | 17.25 | c | 22.25 | c | 55.00 | cd | 82.25 | cd | 95.00 | cd |
| 4 | 200 | g ai/a | A | 0.25 | c | 8.50 | c | 11.00 | c | 32.00 | cd | 52.75 | d | 59.00 | d |
| 5 | 4.0 | lb/a | A | 139.75 | b | 216.75 | b | 241.50 | b | 277.00 | b | 317.00 | b | 328.50 | b |
| 6 | 100 | g ai/a | A | 1.00 | c | 10.00 | c | 15.25 | c | 46.75 | cd | 80.25 | cd | 89.75 | cd |
| | 3.0 | lb/a | | | | | | | | | | | | | |
| 7 | 150 | g ai/a | A | 0.00 | c | 5.25 | c | 7.00 | c | 31.25 | cd | 49.50 | d | 58.50 | d |
| | 2.0 | lb/a | | | | | | | | | | | | | |
| 8 | 200 | g ai/a | A | 0.50 | c | 3.75 | c | 6.75 | c | 23.50 | d | 40.25 | d | 44.00 | d |

| | |
|---|---|
| 1.0 | lb/a |

Timings for Table 14 are the same as those for Table 2.

TABLE 15
Percent Control. Average percent control of broadleaf weeds listed by date per treatment.

| | | | | Week | Week | Week | Week | Week | Week |
|---|---|---|---|---|---|---|---|---|---|
| Trt. No. | Rate | | Time | 2 | 4 | 6 | 10 | 14 | 20 |
| 1 | — | | — | 0.00 | 0.00 | 0.00 | 0.00 | 0.00 | 0.00 |
| 2 | 100 | g ai/a | A | 97.46 | 96.13 | 95.34 | 90.61 | 87.16 | 85.76 |
| 3 | 150 | g ai/a | A | 99.80 | 97.48 | 97.20 | 93.82 | 91.43 | 90.34 |
| 4 | 200 | g ai/a | A | 99.93 | 98.76 | 98.61 | 96.40 | 94.51 | 94.00 |
| 5 | 4.0 | lb/a | A | 62.63 | 68.36 | 69.57 | 68.86 | 66.98 | 66.59 |
| 6 | 100 | g ai/a | A | 99.73 | 98.54 | 98.08 | 94.74 | 91.64 | 90.87 |
| | 3.0 | lb/a | | | | | | | |
| 7 | 150 | g ai/a | A | 100.00 | 99.23 | 99.12 | 96.49 | 94.84 | 94.05 |
| | 2.0 | lb/a | | | | | | | |
| 8 | 200 | g ai/a | A | 99.87 | 99.45 | 99.15 | 97.36 | 95.71 | 95.53 |
| | 1.0 | lb/a | | | | | | | |

Timings for Table 15 are the same as those for Table 2.

Evaluations consisted of a stand count and weed counts identified by species evaluated at weeks 2, 4, 6, 10, 14, and 20. Tables 14 and 15 reflect the average total weed count and average percent control for all weeds when soils were subjected to treatments according to the timing indicated at weeks 2, 4, 6, 10, 14, and 20 respectively (provided in Tables 2-13). Tables 14 and 15 indicate that treatments 2-8 provided improvement over the control. Tables 14 and 15 also indicate that treatments 6-8 (thaxtomin+Kerb®) provide improvement in controlling weeds over treatment 5 (Kerb® 4 lb/a alone) at weeks 2, 4, 6, 10, 14, and 20.

Tables 14 and 15 also indicate that treatment 6 (thaxtomin 100 g ai/a+Kerb® 3 lb/a) provided improved weed control over treatment 2 (thaxtomin 100 g ai/a) at weeks 2, 4, 6, 10, 14, and 20 and treatment 3 (thaxtomin 150 g ai/i) at weeks 4, 6, 10, 14, and 20.

Tables 14 and 15 further show that treatment 7 (thaxtomin 150 g ai/a+Kerb® 2 lb/a) provided improved weed control over treatments 2, 3, and treatment 4 (thaxtomin 200 g ai/a) at weeks 2, 4, 6, 10, 14, and 20. Finally, Tables 14 and 15 indicate that treatment 8 (thaxtomin 200 g ai/a+Kerb® 1 lb/a) provided improved weed control over treatments 2 and 3 at weeks 2, 4, 6, 10, 14, and 20 and treatment 4 at weeks 4, 6, 10, 14, and 20.

### Example 2

This study was conducted in Florida (USA) and consisted of eight (8) treatments made at a single application time (i.e., “Time A”). The trial was conducted identify the benefits of the chemical standard herbicide (Kerb®—Pronamide by Dow AgroSciences) when combined with thaxtomin for improved weed control efficacy and weed spectrum to decrease the application rate of Kerb® in an attempt to decrease the plant restrictions for Kerb® applications.

Treatment applications were made with a CO₂ powered backpack sprayer using 11015 flat fan nozzles applying 628.5 gallons per acre at 80 psi. The treatments consisted of an untreated check, Kerb®, thaxtomin and Kerb® combinations with thaxtomin treatments. The following treatments were applied and correspond to Tables 16-19:
Treatment 1. Untreated check/control (designated as “--”);
Treatment 2. Kerb® applied as a spray at a rate of 2.5 lb/acre;
Treatment 3. Thaxtomin at 86 mg/L applied as a spray at a rate of 100 g ai/acre;
Treatment 4. Thaxtomin at 86 mg/L applied as a spray at a rate of 150 g ai/acre;
Treatment 5. Thaxtomin at 86 mg/L applied as a spray at a rate of 200 g ai/acre;
Treatment 6. Thaxtomin at 86 mg/L applied as a spray at a rate of 100 g ai/acre in combination with Kerb® applied as a spray at 2.0 lb/acre;
Treatment 7. Thaxtomin at 86 mg/L applied as a spray at a rate of 150 g ai/acre in combination with Kerb® applied as a spray at 1.0 lb/acre; and
Treatment 8. Thaxtomin at 86 mg/L applied as a spray at a rate of 200 g ai/acre in combination with Kerb® applied as a spray at 0.5 lb/acre.

Weed control evaluations were carried out by species and evaluated at 20 days after planting (DAP), 34 DAP, 50 DAP, and 71 DAP respectively. Results are provided in Tables 16-19.

TABLE 16
Percent Control. Average percent control of broadleaf
weeds listed by species per treatment at 20 DAP.

| Trt. No. | Rate | Time | AMALI | ELEIN |
|---|---|---|---|---|
| 1 | — | — | 0.00 b | 0.00 b |

| | | | | | |
|---|---|---|---|---|---|
| 2 | 2.5 | lb/a | A | 100.00 a | 100.00 a |
| 3 | 100 | g ai/a | A | 100.00 a | 100.00 a |
| 4 | 150 | g ai/a | A | 100.00 a | 100.00 a |
| 5 | 200 | g ai/a | A | 100.00 a | 100.00 a |
| 6 | 100 | g ai/a | A | 100.00 a | 100.00 a |
| | 2.0 | lb/a | | | |
| 7 | 150 | g ai/a | A | 100.00 a | 100.00 a |
| | 1.0 | lb/a | | | |
| 8 | 200 | g ai/a | A | 100.00 a | 100.00 a |
| | 0.5 | lb/a | | | |

Time “A” indicates application of treatments to the soil surface before the weed(s) has emerged.

TABLE 17
Percent Control. Average percent control of broadleaf weeds listed by
species per treatment at 34 DAP.

| Trt. No. | Rate | | Time | AMALI | ELEIN | CARPA | AMBEL |
|---|---|---|---|---|---|---|---|
| 1 | — | | — | 0.00 c | 0.00 c | 0.00 c | 0.00 b |
| 2 | 2.5 | lb/a | A | 88.8 b | 95.0 b | 81.3 b | 58.8 a |
| 3 | 100 | g ai/a | A | 87.5 b | 95.0 b | 91.3 a | 80.0 a |
| 4 | 150 | g ai/a | A | 98.8 a | 97.5 ab | 96.3 a | 97.5 a |
| 5 | 200 | g ai/a | A | 98.8 a | 100.0 a | 100.0 a | 100.0 a |
| 6 | 100 | g ai/a | A | 98.8 a | 98.8 ab | 93.8 a | 92.0 a |
| | 2.0 | lb/a | | | | | |
| 7 | 150 | g ai/a | A | 100.0 a | 100.0 a | 96.3 a | 93.8 a |
| | 1.0 | lb/a | | | | | |
| 8 | 200 | g ai/a | A | 100.0 a | 100.0 a | 100.0 a | 75.0 a |
| | 0.5 | lb/a | | | | | |

Timings for Table 17 are the same as those for Table 16.

TABLE 18
Percent Control. Average percent control of broadleaf weeds listed by
species per treatment at 50 DAP.

| Trt. No. | Rate | | Time | AMALI | ELEIN | CARPA | AMBEL |
|---|---|---|---|---|---|---|---|
| 1 | — | | — | 0.00 c | 0.00 c | 0.00 c | 0.00 c |
| 2 | 2.5 | lb/a | A | 66.3 b | 88.8 b | 77.5 b | 57.5 b |
| 3 | 100 | g ai/a | A | 73.8 b | 94.5 a | 86.3 ab | 91.3 a |
| 4 | 150 | g ai/a | A | 91.3 a | 95.8 a | 96.5 a | 93.8 a |
| 5 | 200 | g ai/a | A | 98.0 a | 98.0 a | 98.0 a | 98.5 a |
| 6 | 100 | g ai/a | A | 87.0 a | 96.5 a | 95.5 a | 89.5 a |
| | 2.0 | lb/a | | | | | |
| 7 | 150 | g ai/a | A | 97.3 a | 97.5 a | 97.3 a | 94.0 a |
| | 1.0 | lb/a | | | | | |
| 8 | 200 | g ai/a | A | 95.3 a | 98.0 a | 97.3 a | 96.0 a |
| | 0.5 | lb/a | | | | | |

Timings for Table 18 are the same as those for Table 16.

TABLE 19
Percent Control. Average percent control of broadleaf weeds listed by
species per treatment at 71 DAP.

| Trt. No. | Rate | | Time | AMALI | ELEIN | CARPA | AMBEL |
|---|---|---|---|---|---|---|---|
| 1 | — | | — | 0.00 c | 0.00 c | 0.00 c | 0.00 c |
| 2 | 2.5 | lb/a | A | 56.3 b | 87.5 b | 67.5 b | 50.0 b |
| 3 | 100 | g ai/a | A | 66.3 b | 93.8 a | 81.3 a | 83.8 a |
| 4 | 150 | g ai/a | A | 83.8 a | 95.0 a | 92.5 a | 88.8 a |
| 5 | 200 | g ai/a | A | 92.5 a | 95.0 a | 93.8 a | 93.8 a |
| 6 | 100 | g ai/a | A | 81.3 a | 95.0 a | 87.5 a | 80.0 a |
| | 2.0 | lb/a | | | | | |
| 7 | 150 | g ai/a | A | 91.3 a | 95.0 a | 92.5 a | 86.3 a |
| | 1.0 | lb/a | | | | | |
| 8 | 200 | g ai/a | A | 90.0 a | 95.0 a | 92.5 a | 92.5 a |
| | 0.5 | lb/a | | | | | |

Timings for Table 19 are the same as those for Table 16.

Tables 16-19 indicate that treatments 6-8 (combinations of Kerb® applied at lower rates with the same rates of thaxtomin in treatments 2-5) improved the weed control compared to treatment 2 (Kerb® at the higher rate of 2.5 lb/a). Overall, treatment 5 (thaxtomin 200 g ai/A) slightly outperformed or equaled the performance of treatments 6-8 for controlling weeds over the weed spectrum present in this trial.

### Example 3

Thaxtomin was applied alone and in combination as a pre-emergence application with Kerb® 50-W (Pronamide) to evaluate weed control and synergies at different rates and application timings while improving weed control efficacy and weeds controlled in combination if they were not controlled alone. Eight (8) treatments were applied at four distinct application times (i.e., “A”, “B”, “C”, and “D”). The treatments consisted of the following applications of an untreated control/check, thaxtomin alone at various concentrations, Kerb® 50-W (Pronamide) herbicide from Dow AgroSciences LLC at various concentrations, and combinations of thaxtomin and Kerb® 50-W herbicide at various concentrations.

Experimental treatments were applied at pre-emergence, before crop emergence, at crop emergence, and at 2-leaf stage. Treatment applications were performed using a CO₂ backpack sprayer with a spray boom incorporating 2 XR TeeJet® flat spray nozzles at 40 psi directed at the soil surface. Water incorporation was applied to the randomized plots by an 8 nozzle water boom.

The following treatments were applied and correspond to Tables 20-29:
Treatment 1. Untreated check/control (designated as “--”);
Treatment 2. Thaxtomin at 77 mg/L applied as a spray at a rate of 100 g ai/acre;
Treatment 3. Kerb® 50-W applied as a spray at a rate of 4.0 lb/acre at pre-emergence rotated with thaxtomin at 77 mg/L applied as a spray at a rate of 100 g ai/acre at prior to emergence;
Treatment 4. Kerb® 50-W applied as a spray at a rate of 4.0 lb/acre at pre-emergence rotated with thaxtomin at 77 mg/L applied as a spray at a rate of 100 g ai/acre at emergence;
Treatment 5. Kerb® 50-W applied as a spray at a rate of 4.0 lb/acre at pre-emergence rotated with thaxtomin at 77 mg/L applied as a spray at a rate of 100 g ai/acre at the 2-leaf stage;
Treatment 6. Thaxtomin at 77 mg/L applied as a spray at a rate of 25 g ai/acre with Kerb® 50-W applied as a spray at a rate of 4.0 lb/acre at pre-emergence rotated with thaxtomin at 77 mg/L applied as a spray at a rate of 100 g ai/acre at emergence;
Treatment 7. Thaxtomin at 77 mg/L applied as a spray at a rate of 50 g ai/acre with Kerb® 50-W applied as a spray at a rate of 4.0 lb/acre at pre-emergence rotated with thaxtomin at 77 mg/L applied as a spray at a rate of 100 g ai/acre at emergence; and
Treatment 8. Kerb® 50-W applied as a spray at a rate of 4.0 lb/acre.

Evaluations consisted of a stand count and weed counts identified by species and evaluated at 2 weeks, 4 weeks, 6 weeks and 8 weeks from the date of “Time A.” Results are provided in Tables 20-29.

TABLE 20
Weed Count. Average broadleaf weed counts listed by species per treatment at 2 weeks.

| Trt. No. | Rate | | Time | SINAR | CAPBP | SENVU | AMARE | POROL |
|---|---|---|---|---|---|---|---|---|
| 1 | — | | — | 29.25 a | 89.75 a | 58.50 b | 191.00 a | 172.00 a |
| 2 | 100 | g ai/a | A | 1.75 b | 0.50 b | 0.00 c | 8.75 b | 1.75 b |
| 3 | 4.0 | lb/a | A | 1.00 b | 0.00 b | 1.50 c | 0.25 b | 0.50 b |
| | 100 | g ai/a | B | | | | | |
| 4 | 4.0 | lb/a | A | 1.00 b | 0.00 b | 0.50 c | 0.75 b | 0.50 b |
| | 100 | g ai/a | C | | | | | |
| 5 | 4.0 | lb/a | A | 3.25 b | 0.00 b | 40.75 bc | 2.00 b | 0.00 b |
| | 100 | g ai/a | D | | | | | |
| 6 | 25 | g ai/a | A | 0.00 b | 0.00 b | 0.00 c | 0.00 b | 0.00 b |
| | 4.0 | lb/a | A | | | | | |
| | 100 | g ai/a | C | | | | | |
| 7 | 50 | g ai/a | A | 0.25 b | 0.00 b | 0.00 c | 0.00 b | 0.00 b |
| | 4.0 | lb/a | A | | | | | |
| | 100 | g ai/a | C | | | | | |
| 8 | 4.0 | lb/a | A | 7.75 b | 0.00 b | 127.75 a | 12.50 b | 0.00 b |
| Trt. No. | Rate | | Time | SPRAR | SOLSA | KCHSC | MALNE | IPOHE |
| 1 | — | | — | 4.75 a | 28.25 a | 18.75 a | 4.75 a | 1.75 a |
| 2 | 100 | g ai/a | A | 0.25 a | 8.75 b | 7.75 b | 4.25 a | 0.00 b |
| 3 | 4.0 | lb/a | A | 0.00 a | 0.25 c | 0.00 b | 2.25 b | 0.00 b |
| | 100 | g ai/a | B | | | | | |
| 4 | 4.0 | lb/a | A | 0.00 a | 0.00 c | 0.00 b | 0.00 c | 0.00 b |
| | 100 | g ai/a | C | | | | | |
| 5 | 4.0 | lb/a | A | 0.00 a | 0.50 c | 0.00 b | 0.75 bc | 0.00 b |
| | 100 | g ai/a | D | | | | | |
| 6 | 25 | g ai/a | A | 0.00 a | 0.00 c | 0.00 b | 0.75 bc | 0.00 b |
| | 4.0 | lb/a | A | | | | | |
| | 100 | g ai/a | C | | | | | |
| 7 | 50 | g ai/a | A | 0.00 a | 0.00 c | 0.00 b | 0.00 c | 0.00 b |
| | 4.0 | lb/a | A | | | | | |
| | 100 | g ai/a | C | | | | | |
| 8 | 4.0 | lb/a | A | 0.00 a | 0.25 c | 0.00 b | 2.00 bc | 0.00 b |

Time “A” indicates application of treatments to the soil surface before the weed(s) has emerged.
Time “B” indicates application of treatments to the soil surface before the crop of interest (Lactuca sativa) emerged.
Time “C” indicates application of treatments to the soil surface at the time the crop of interest (Lactuca sativa) emerged.
Time “D” indicated treatments to the soil surface at the time when the crop of interest (Lactuca sativa) reached the 2-leaf stage.

TABLE 21
Percent Control. Average percent control of broadleaf weeds listed by species per treatment at 2 weeks.

| Trt. No. | Rate | | Time | SINAR | CAPBP | SENVU | AMARE | POROL |
|---|---|---|---|---|---|---|---|---|
| 1 | — | | — | 0.00 g | 0.00 c | 0.00 e | 0.00 g | 0.00 d |
| 2 | 100 | g ai/a | A | 94.02 d | 99.44 b | 100.00 a | 95.42 e | 98.98 c |
| 3 | 4.0 | lb/a | A | 96.58 c | 100.00 a | 97.44 c | 99.87 b | 99.71 b |
| | 100 | g ai/a | B | | | | | |
| 4 | 4.0 | lb/a | A | 96.58 e | 100.00 a | 99.15 b | 99.61 c | 99.71 b |
| | 100 | g ai/a | C | | | | | |
| 5 | 4.0 | lb/a | A | 88.89 a | 100.00 a | 30.34 d | 98.95 d | 100.00 a |
| | 100 | g ai/a | D | | | | | |
| 6 | 25 | g ai/a | A | 100.00 a | 100.00 a | 100.00 a | 100.00 a | 100.00 a |
| | 4.0 | lb/a | A | | | | | |
| | 100 | g ai/a | C | | | | | |
| 7 | 50 | g ai/a | A | 99.15 b | 100.00 a | 100.00 a | 100.00 a | 100.00 a |
| | 4.0 | lb/a | A | | | | | |
| | 100 | g ai/a | C | | | | | |
| 8 | 4.0 | lb/a | A | 73.50 f | 100.00 a | 0.00 e | 93.46 f | 100.00 a |
| Trt. No. | Rate | | Time | SPRAR | SOLSA | KCHSC | MALNE | IPOHE |
| 1 | — | | — | 0.00 c | 0.00 e | 0.00 c | 0.00 f | 0.00 b |
| 2 | 100 | g ai/a | A | 94.74 b | 69.03 d | 58.67 b | 10.53 e | 100.00 a |
| 3 | 4.0 | lb/a | A | 100.00 a | 99.12 b | 100.00 a | 52.63 d | 100.00 a |
| | 100 | g ai/a | B | | | | | |
| 4 | 4.0 | lb/a | A | 100.00 a | 100.00 a | 100.00 a | 100.00 a | 100.00 a |
| | 100 | g ai/a | C | | | | | |
| 5 | 4.0 | lb/a | A | 100.00 a | 98.23 c | 100.00 a | 84.21 b | 100.00 a |
| | 100 | g ai/a | D | | | | | |
| 6 | 25 | g ai/a | A | 100.00 a | 100.00 a | 100.00 a | 84.21 b | 100.00 a |
| | 4.0 | lb/a | A | | | | | |
| | 100 | g ai/a | C | | | | | |
| 7 | 50 | g ai/a | A | 100.00 a | 100.00 a | 100.00 a | 100.00 a | 100.00 a |
| | 4.0 | lb/a | A | | | | | |
| | 100 | g ai/a | C | | | | | |
| 8 | 4.0 | lb/a | A | 100.00 a | 99.12 b | 100.00 a | 57.89 c | 100.00 a |

Timings for Table 21 are the same as those for Table 20.

TABLE 22
Weed Count. Average broadleaf weed counts listed by species per treatment at 4 weeks.

| Trt. No. | Rate | Time | SINAR | CAPBP | SENVU | AMARE | POROL | SPRAR | SOLSA |
|---|---|---|---|---|---|---|---|---|---|
| 1 | — | — | 29.50 a | 101.25 a | 63.50 b | 194.50 a | 180.00 a | 6.00 a | 31.25 a |
| 2 | 100 g | A | 3.25 b | 15.00 a | 1.75 b | 17.75 b | 7.75 b | 2.00 a | 15.25 b |
| | ai/a | | | | | | | | |
| 3 | 4.0 lb/a | A | 1.00 b | 25.25 a | 6.50 b | 6.00 b | 1.00 b | 0.00 a | 2.75 c |
| | 100 g | B | | | | | | | |
| | ai/a | | | | | | | | |
| 4 | 4.0 lb/a | A | 1.75 b | 9.50 a | 9.50 b | 1.75 b | 0.75 b | 0.00 a | 1.25 c |
| | 100 g | C | | | | | | | |
| | ai/a | | | | | | | | |
| 5 | 4.0 lb/a | A | 3.75 b | 10.50 a | 64.75 b | 6.75 b | 0.25 b | 0.00 a | 0.50 c |
| | 100 g | D | | | | | | | |
| | ai/a | | | | | | | | |
| 6 | 25 g ai/a | A | 0.50 b | 15.75 a | 4.75 b | 3.25 b | 0.00 b | 0.00 a | 1.25 c |
| | 4.0 lb/a | A | | | | | | | |
| | 100 g | C | | | | | | | |
| | ai/a | | | | | | | | |
| 7 | 50 g ai/a | A | 0.25 b | 5.75 a | 1.25 b | 0.50 b | 0.50 b | 0.00 a | 0.25 c |
| | 4.0 lb/a | A | | | | | | | |
| | 100 g | C | | | | | | | |
| | ai/a | | | | | | | | |
| 8 | 4.0 lb/a | A | 8.25 b | 14.00 a | 153.50 a | 18.50 b | 0.00 b | 0.00 a | 1.50 c |

| Trt. No. | Rate | Time | KCHSC | MALNE | | IPOHE | MATMT | | CHEAL | | CERSS |
|---|---|---|---|---|---|---|---|---|---|---|---|
| 1 | — | — | 23.50 a | 5.25 | ab | 1.75 a | 6.00 | b | 14.75 | a | 2.50 a |
| 2 | 100 g | A | 30.75 a | 11.75 | a | 0.00 b | 1.75 | bc | 4.75 | b | 4.50 a |
| | ai/a | | | | | | | | | | |
| 3 | 4.0 lb/a | A | 0.75 b | 6.75 | ab | 0.00 b | 1.75 | c | 8.25 | ab | 1.25 a |
| | 100 g | B | | | | | | | | | |
| | ai/a | | | | | | | | | | |
| 4 | 4.0 lb/a | A | 0.00 b | 5.00 | ab | 0.00 b | 0.50 | c | 10.00 | ab | 0.50 a |
| | 100 g | C | | | | | | | | | |
| | ai/a | | | | | | | | | | |
| 5 | 4.0 lb/a | A | 0.00 b | 3.25 | b | 0.00 b | 0.75 | c | 2.75 | b | 1.00 a |
| | 100 g | D | | | | | | | | | |
| | ai/a | | | | | | | | | | |
| 6 | 25 g ai/a | A | 0.25 b | 5.00 | ab | 0.00 b | 2.75 | bc | 8.00 | ab | 1.50 a |
| | 4.0 lb/a | A | | | | | | | | | |
| | 100 g | C | | | | | | | | | |
| | ai/a | | | | | | | | | | |
| 7 | 50 g ai/a | A | 0.75 b | 3.75 | b | 0.00 b | 0.50 | c | 4.75 | b | 0.50 a |
| | 4.0 lb/a | A | | | | | | | | | |
| | 100 g | C | | | | | | | | | |
| | ai/a | | | | | | | | | | |
| 8 | 4.0 lb/a | A | 0.00 b | 3.50 | b | 0.00 b | 10.00 | a | 6.00 | b | 1.00 a |

Timings for Table 22 are the same as those for Table 20.

TABLE 23
Percent Control. Average percent control of broadleaf weeds listed by species per treatment at 4 weeks.

| Trt. No. | Rate | | Time | SINAR | CAPBP | SENVU | AMARE | POROL | SPRAR | SOLSA |
|---|---|---|---|---|---|---|---|---|---|---|
| 1 | — | | — | 0.00 h | 0.00 h | 0.00 f | 0.00 h | 0.00 g | 0.00 c | 0.00 g |
| 2 | 100 | g ai/a | A | 88.98 e | 85.19 e | 97.24 b | 90.87 f | 95.69 f | 66.67 b | 51.20 f |
| 3 | 4.0 | lb/a | A | 96.61 c | 75.06 g | 89.76 d | 96.92 d | 99.44 e | 100.00 a | 91.20 e |
| | 100 | g ai/a | B | | | | | | | |
| 4 | 4.0 | lb/a | A | 94.07 d | 90.62 b | 85.04 e | 99.10 b | 99.58 d | 100.00 a | 96.00 c |
| | 100 | g ai/a | C | | | | | | | |
| 5 | 4.0 | lb/a | A | 87.29 f | 89.63 c | 0.00 f | 96.53 e | 99.86 b | 100.00 a | 98.40 b |
| | 100 | g ai/a | D | | | | | | | |
| 6 | 25 | g ai/a | A | 98.31 b | 84.44 f | 92.52 c | 98.33 c | 100.00 a | 100.00 a | 96.00 c |
| | 4.0 | lb/a | A | | | | | | | |
| | 100 | g ai/a | C | | | | | | | |
| 7 | 50 | g ai/a | A | 99.15 a | 94.32 a | 98.03 a | 99.74 a | 99.72 c | 100.00 a | 99.20 a |
| | 4.0 | lb/a | A | | | | | | | |
| | 100 | g ai/a | C | | | | | | | |
| 8 | 4.0 | lb/a | A | 72.03 g | 86.17 d | 0.00 f | 90.49 g | 100.00 a | 100.00 a | 95.20 d |

| Trt. No. | Rate | | Time | KCHSC | MALNE | IPOHE | MATMT | CHEAL | CERSS |
|---|---|---|---|---|---|---|---|---|---|
| 1 | — | | — | 0.00 d | 0.00 e | 0.00 b | 0.00 e | 0.00 g | 0.00 e |
| 2 | 100 | g ai/a | A | 0.00 d | 0.00 e | 100.00 a | 70.83 c | 67.80 b | 0.00 e |
| 3 | 4.0 | lb/a | A | 96.81 c | 0.00 e | 100.00 a | 70.83 c | 44.07 e | 50.00 c |
| | 100 | g ai/a | B | | | | | | |
| 4 | 4.0 | lb/a | A | 100.00 a | 4.76 d | 100.00 a | 91.67 a | 32.20 f | 80.00 a |
| | 100 | g ai/a | C | | | | | | |
| 5 | 4.0 | lb/a | A | 100.00 a | 38.10 a | 100.00 a | 84.50 b | 81.36 a | 60.00 b |
| | 100 | g ai/a | D | | | | | | |
| 6 | 25 | g ai/a | A | 98.94 b | 4.76 d | 100.00 a | 54.17 d | 45.76 d | 40.00 d |
| | 4.0 | lb/a | A | | | | | | |
| | 100 | g ai/a | C | | | | | | |
| 7 | 50 | g ai/a | A | 96.81 c | 28.57 c | 100.00 a | 91.67 a | 67.80 b | 80.00 a |
| | 4.0 | lb/a | A | | | | | | |
| | 100 | g ai/a | C | | | | | | |
| 8 | 4.0 | lb/a | A | 100.00 a | 33.33 b | 100.00 a | 0.00 e | 59.32 c | 60.00 b |

Timings for Table 23 are the same as those for Table 20.

TABLE 24
Weed Count. Average broadleaf weed counts listed by species per treatment at 6 weeks.

| Trt. No. | Rate | | Time | SINAR | | CAPBP | SENVU | AMARE |
|---|---|---|---|---|---|---|---|---|
| 1 | — | | — | 29.75 a | | 116.00 a | 74.50 b | 206.50 a |
| 2 | 100 | g ai/a | A | 3.50 b | | 20.25 b | 2.50 c | 19.50 b |
| 3 | 4.0 | lb/a | A | 1.50 b | | 32.75 b | 8.00 c | 8.00 b |
| | 100 | g ai/a | B | | | | | |
| 4 | 4.0 | lb/a | A | 1.75 b | | 14.75 b | 12.00 c | 4.25 b |
| | 100 | g ai/a | C | | | | | |
| 5 | 4.0 | lb/a | A | 4.00 b | | 14.00 b | 69.00 b | 7.75 b |
| | 100 | g ai/a | D | | | | | |
| 6 | 25 | g ai/a | A | 0.75 b | | 19.75 b | 6.00 c | 4.50 b |
| | 4.0 | lb/a | A | | | | | |
| | 100 | g ai/a | C | | | | | |
| 7 | 50 | g ai/a | A | 0.75 b | | 7.50 b | 1.75 c | 1.25 b |
| | 4.0 | lb/a | A | | | | | |
| | 100 | g ai/a | C | | | | | |
| 8 | 4.0 | lb/a | A | 8.50 b | | 19.75 b | 163.25 a | 20.75 b |
| Trt. No. | Rate | | Time | POROL | | SPRAR | SOLSA | KCHSC |
| 1 | — | | — | 190.00 a | | 6.75 a | 35.50 | 27.25 a |
| 2 | 100 | g ai/a | A | 10.00 b | | 2.00 a | 16.00 | 33.50 a |
| 3 | 4.0 | lb/a | A | 1.50 b | | 0.00 a | 3.25 | 1.25 b |
| | 100 | g ai/a | B | | | | | |
| 4 | 4.0 | lb/a | A | 1.25 b | | 0.00 a | 1.50 | 0.25 b |
| | 100 | g ai/a | C | | | | | |
| 5 | 4.0 | lb/a | A | 0.75 b | | 0.00 a | 0.50 | 0.50 b |
| | 100 | g ai/a | D | | | | | |
| 6 | 25 | g ai/a | A | 1.25 b | | 0.00 a | 1.75 | 0.50 b |
| | 4.0 | lb/a | A | | | | | |
| | 100 | g ai/a | C | | | | | |
| 7 | 50 | g ai/a | A | 0.75 b | | 0.00 a | 0.75 | 1.00 b |
| | 4.0 | lb/a | A | | | | | |
| | 100 | g ai/a | C | | | | | |
| 8 | 4.0 | lb/a | A | 0.00 b | | 0.00 a | 2.00 | 0.00 b |
| Trt. No. | Rate | | Time | MALNE | | IPOHE | MATMT | CHEAL |
| 1 | — | | — | 6.75 | ab | 1.75 a | 11.00 a | 18.50 a |
| 2 | 100 | g ai/a | A | 12.25 | a | 0.00 b | 3.25 b | 12.50 a |
| 3 | 4.0 | lb/a | A | 7.50 | ab | 0.00 b | 5.25 b | 14.75 a |
| | 100 | g ai/a | B | | | | | |
| 4 | 4.0 | lb/a | A | 5.75 | ab | 0.00 b | 2.00 b | 18.25 a |
| | 100 | g ai/a | C | | | | | |
| 5 | 4.0 | lb/a | A | 4.25 | b | 0.00 b | 2.50 b | 6.75 a |
| | 100 | g ai/a | D | | | | | |
| 6 | 25 | g ai/a | A | 6.25 | ab | 0.00 b | 5.75 b | 18.75 a |
| | 4.0 | lb/a | A | | | | | |
| | 100 | g ai/a | C | | | | | |
| 7 | 50 | g ai/a | A | 5.25 | ab | 0.00 b | 1.75 b | 12.25 a |
| | 4.0 | lb/a | A | | | | | |
| | 100 | g ai/a | C | | | | | |
| 8 | 4.0 | lb/a | A | 4.00 | b | 0.00 b | 14.75 a | 8.50 a |

| Trt. No. | Rate | | Time | CERSS | MEDPO | POLSS | SONSS |
|---|---|---|---|---|---|---|---|
| 1 | — | | — | 4.25 a | 2.25 a | 1.00 a | 0.50 a |
| 2 | 100 | g ai/a | A | 5.25 a | 0.50 a | 2.00 a | 0.00 a |
| 3 | 4.0 | lb/a | A | 1.75 a | 1.50 a | 0.00 a | 0.25 a |
| | 100 | g ai/a | B | | | | |
| 4 | 4.0 | lb/a | A | 1.75 a | 1.50 a | 0.00 a | 0.25 a |
| | 100 | g ai/a | C | | | | |
| 5 | 4.0 | lb/a | A | 1.25 a | 0.50 a | 0.00 a | 0.00 a |
| | 100 | g ai/a | D | | | | |
| 6 | 25 | g ai/a | A | 1.75 a | 0.75 a | 0.00 a | 0.50 a |
| | 4.0 | lb/a | A | | | | |
| | 100 | g ai/a | C | | | | |
| 7 | 50 | g ai/a | A | 1.25 a | 0.25 a | 0.00 a | 0.00 a |
| | 4.0 | lb/a | A | | | | |
| | 100 | g ai/a | C | | | | |
| 8 | 4.0 | lb/a | A | 1.25 a | 1.75 a | 0.00 a | 1.75 a |

Timings for Table 24 are the same as those for Table 20.

TABLE 25
Percent Control. Average percent control of broadleaf weeds listed by species per treatment
at 6 weeks.

| Trt. No. | Rate | | Time | SINAR | CAPBP | SENVU | AMARE |
|---|---|---|---|---|---|---|---|
| 1 | — | | — | 0.00 g | 0.00 g | 0.00 g | 0.00 h |
| 2 | 100 | g ai/a | A | 88.24 d | 82.54 e | 96.64 b | 90.56 f |
| 3 | 4.0 | lb/a | A | 94.96 b | 71.77 f | 89.26 d | 96.13 e |
| | 100 | g ai/a | B | | | | |
| 4 | 4.0 | lb/a | A | 94.12 c | 87.28 c | 83.89 e | 97.94 b |
| | 100 | g ai/a | C | | | | |
| 5 | 4.0 | lb/a | A | 86.55 e | 87.93 b | 7.38 f | 96.25 d |
| | 100 | g ai/a | D | | | | |
| 6 | 25 | g ai/a | A | 97.48 a | 82.97 d | 91.95 c | 97.82 c |
| | 4.0 | lb/a | A | | | | |
| | 100 | g ai/a | C | | | | |
| 7 | 50 | g ai/a | A | 97.48 a | 93.53 a | 97.65 a | 99.39 a |
| | 4.0 | lb/a | A | | | | |
| | 100 | g ai/a | C | | | | |
| 8 | 4.0 | lb/a | A | 71.43 f | 82.97 d | 0.00 g | 89.95 g |
| Trt. No. | Rate | | Time | POROL | SPRAR | SOLSA | KCHSC |
| 1 | — | | — | 0.00 f | 0.00 c | 0.00 h | 0.00 f |
| 2 | 100 | g ai/a | A | 94.74 e | 70.37 b | 54.93 g | 0.00 f |
| 3 | 4.0 | lb/a | A | 99.21 d | 100.00 a | 90.85 f | 95.41 e |
| | 100 | g ai/a | B | | | | |
| 4 | 4.0 | lb/a | A | 99.34 c | 100.00 a | 95.77 c | 99.08 b |
| | 100 | g ai/a | C | | | | |
| 5 | 4.0 | lb/a | A | 99.61 b | 100.00 a | 98.59 a | 98.17 c |
| | 100 | g ai/a | D | | | | |
| 6 | 25 | g ai/a | A | 99.34 c | 100.00 a | 95.07 d | 98.17 c |
| | 4.0 | lb/a | A | | | | |
| | 100 | g ai/a | C | | | | |
| 7 | 50 | g ai/a | A | 99.61 b | 100.00 a | 97.89 b | 96.33 d |
| | 4.0 | lb/a | A | | | | |
| | 100 | g ai/a | C | | | | |
| 8 | 4.0 | lb/a | A | 100.00 a | 100.00 a | 94.37 e | 100.00 a |
| Trt. No. | Rate | | Time | MALNE | IPOHE | MATMT | CHEAL |
| 1 | — | | — | 0.00 f | 0.00 b | 0.00 g | 0.00 g |
| 2 | 100 | g ai/a | A | 0.00 f | 100.00 a | 70.45 d | 32.43 d |
| 3 | 4.0 | lb/a | A | 0.00 f | 100.00 a | 52.27 e | 20.27 e |
| | 100 | g ai/a | B | | | | |
| 4 | 4.0 | lb/a | A | 14.81 d | 100.00 a | 81.82 b | 1.35 f |
| | 100 | g ai/a | C | | | | |
| 5 | 4.0 | lb/a | A | 37.04 b | 100.00 a | 77.27 c | 63.51 a |
| | 100 | g ai/a | D | | | | |
| 6 | 25 | g ai/a | A | 7.41 e | 100.00 a | 47.73 f | 0.00 g |
| | 4.0 | lb/a | A | | | | |
| | 100 | g ai/a | C | | | | |
| 7 | 50 | g ai/a | A | 22.22 c | 100.00 a | 84.09 a | 33.78 c |
| | 4.0 | lb/a | A | | | | |
| | 100 | g ai/a | C | | | | |
| 8 | 4.0 | lb/a | A | 40.74 a | 100.00 a | 0.00 g | 54.05 b |
| Trt. No. | Rate | | Time | CERSS | MEDPO | POLSS | SONSS |
| 1 | — | | — | 0.00 c | 0.00 f | 0.00 b | 0.00 c |
| 2 | 100 | g ai/a | A | 0.00 c | 77.78 b | 0.00 b | 100.00 a |
| 3 | 4.0 | lb/a | A | 58.82 b | 33.33 d | 100.00 a | 50.00 b |
| | 100 | g ai/a | B | | | | |
| 4 | 4.0 | lb/a | A | 58.82 b | 33.33 d | 100.00 a | 50.00 b |
| | 100 | g ai/a | C | | | | |
| 5 | 4.0 | lb/a | A | 70.59 a | 77.78 b | 100.00 a | 100.00 a |
| | 100 | g ai/a | D | | | | |
| 6 | 25 | g ai/a | A | 58.82 b | 66.67 c | 100.00 a | 0.00 c |
| | 4.0 | lb/a | A | | | | |
| | 100 | g ai/a | C | | | | |
| 7 | 50 | g ai/a | A | 70.59 a | 88.89 a | 100.00 a | 100.00 a |
| | 4.0 | lb/a | A | | | | |
| | 100 | g ai/a | C | | | | |
| 8 | 4.0 | lb/a | A | 70.59 a | 22.22 e | 100.00 a | 0.00 c |

Timings for Table 25 are the same as those for Table 20.

TABLE 26
Weed Count. Average broadleaf weed counts listed by species per treatment at 8 weeks.

| Trt. No. | Rate | | Time | SINAR | | CAPBP | SENVU | AMARE |
|---|---|---|---|---|---|---|---|---|
| 1 | — | | — | 29.75 a | | 119.00 a | 78.25 b | 208.00 a |
| 2 | 100 | g ai/a | A | 3.50 b | | 21.50 b | 3.00 c | 20.00 b |
| 3 | 4.0 | lb/a | A | 1.50 b | | 34.50 b | 8.00 c | 9.50 b |
| | 100 | g ai/a | B | | | | | |
| 4 | 4.0 | lb/a | A | 2.00 b | | 16.50 b | 13.00 c | 4.50 b |
| | 100 | g ai/a | C | | | | | |
| 5 | 4.0 | lb/a | A | 4.25 b | | 15.50 b | 71.25 b | 8.25 b |
| | 100 | g ai/a | D | | | | | |
| 6 | 25 | g ai/a | A | 0.75 b | | 21.25 b | 6.50 c | 5.25 b |
| | 4.0 | lb/a | A | | | | | |
| | 100 | g ai/a | C | | | | | |
| 7 | 50 | g ai/a | A | 0.75 b | | 8.75 b | 2.25 c | 1.25 b |
| | 4.0 | lb/a | A | | | | | |
| | 100 | g ai/a | C | | | | | |
| 8 | 4.0 | lb/a | A | 8.50 b | | 22.00 b | 166.25 a | 20.75 b |
| Trt. No. | Rate | | Time | POROL | | SPRAR | SOLSA | KCHSC |
| 1 | — | | — | 193.75 a | | 6.75 a | 36.00 a | 28.00 a |
| 2 | 100 | g ai/a | A | 10.75 b | | 2.00 a | 16.25 b | 33.75 a |
| 3 | 4.0 | lb/a | A | 2.25 b | | 0.00 a | 3.25 c | 1.25 b |
| | 100 | g ai/a | B | | | | | |
| 4 | 4.0 | lb/a | A | 1.25 b | | 0.00 a | 1.50 c | 0.50 b |
| | 100 | g ai/a | C | | | | | |
| 5 | 4.0 | lb/a | A | 1.00 b | | 0.00 a | 0.50 c | 0.75 b |
| | 100 | g ai/a | D | | | | | |
| 6 | 25 | g ai/a | A | 1.50 b | | 0.00 a | 2.00 c | 0.75 b |
| | 4.0 | lb/a | A | | | | | |
| | 100 | g ai/a | C | | | | | |
| 7 | 50 | g ai/a | A | 1.25 b | | 0.00 a | 0.75 c | 1.25 b |
| | 4.0 | lb/a | A | | | | | |
| | 100 | g ai/a | C | | | | | |
| 8 | 4.0 | lb/a | A | 0.25 b | | 0.00 a | 2.00 c | 0.00 b |
| Trt. No. | Rate | | Time | MALNE | | IPOHE | MATMT | CHEAL |
| 1 | — | | — | 7.50 | ab | 1.75 a | 13.25 a | 19.75 a |
| 2 | 100 | g ai/a | A | 13.00 | a | 0.00 b | 3.50 b | 12.50 a |
| 3 | 4.0 | lb/a | A | 8.50 | ab | 0.00 b | 5.75 b | 16.00 a |
| | 100 | g ai/a | B | | | | | |
| 4 | 4.0 | lb/a | A | 6.25 | ab | 0.00 b | 4.25 b | 19.25 a |
| | 100 | g ai/a | C | | | | | |
| 5 | 4.0 | lb/a | A | 5.50 | b | 0.00 b | 3.00 b | 7.75 a |
| | 100 | g ai/a | D | | | | | |
| 6 | 25 | g ai/a | A | 7.00 | ab | 0.00 b | 6.00 b | 19.75 a |
| | 4.0 | lb/a | A | | | | | |
| | 100 | g ai/a | C | | | | | |
| 7 | 50 | g ai/a | A | 5.25 | b | 0.00 b | 2.00 b | 12.50 a |
| | 4.0 | lb/a | A | | | | | |
| | 100 | g ai/a | C | | | | | |
| 8 | 4.0 | lb/a | A | 4.50 | b | 0.00 b | 15.50 b | 9.50 a |

| Trt. No. | Rate | | Time | CERSS | MEDPO | POLSS | SONSS |
|---|---|---|---|---|---|---|---|
| 1 | — | | — | 5.25 a | 2.25 a | 1.00 a | 0.50 a |
| 2 | 100 | g ai/a | A | 5.75 a | 0.50 a | 2.00 a | 0.00 a |
| 3 | 4.0 | lb/a | A | 2.00 a | 1.50 a | 0.00 a | 0.25 a |
| | 100 | g ai/a | B | | | | |
| 4 | 4.0 | lb/a | A | 2.75 a | 1.50 a | 0.00 a | 0.25 a |
| | 100 | g ai/a | C | | | | |
| 5 | 4.0 | lb/a | A | 1.75 a | 0.50 a | 0.00 a | 0.00 a |
| | 100 | g ai/a | D | | | | |
| 6 | 25 | g ai/a | A | 2.50 a | 0.75 a | 0.00 a | 0.50 a |
| | 4.0 | lb/a | A | | | | |
| | 100 | g ai/a | C | | | | |
| 7 | 50 | g ai/a | A | 1.50 a | 0.25 a | 0.00 a | 0.00 a |
| | 4.0 | lb/a | A | | | | |
| | 100 | g ai/a | C | | | | |
| 8 | 4.0 | lb/a | A | 1.75 a | 1.75 a | 0.00 a | 1.75 a |

Timings for Table 26 are the same as those for Table 20.

TABLE 27
Percent Control. Average percent control of broadleaf weeds listed by species per treatment
at 8 weeks.

| Trt. No. | Rate | | Time | SINAR | CAPBP | SENVU | AMARE |
|---|---|---|---|---|---|---|---|
| 1 | — | | — | 0.00 g | 0.00 h | 0.00 g | 0.00 h |
| 2 | 100 | g ai/a | A | 88.24 d | 81.93 e | 96.17 b | 90.38 f |
| 3 | 4.0 | lb/a | A | 94.96 b | 71.01 g | 89.78 d | 95.43 e |
| | 100 | g ai/a | B | | | | |
| 4 | 4.0 | lb/a | A | 93.28 c | 86.13 c | 83.39 e | 97.84 b |
| | 100 | g ai/a | C | | | | |
| 5 | 4.0 | lb/a | A | 85.71 e | 86.97 b | 8.95 f | 96.03 d |
| | 100 | g ai/a | D | | | | |
| 6 | 25 | g ai/a | A | 97.48 a | 82.14 d | 91.69 c | 97.48 c |
| | 4.0 | lb/a | A | | | | |
| | 100 | g ai/a | C | | | | |
| 7 | 50 | g ai/a | A | 97.48 a | 92.65 a | 97.12 a | 99.40 a |
| | 4.0 | lb/a | A | | | | |
| | 100 | g ai/a | C | | | | |
| 8 | 4.0 | lb/a | A | 71.43 f | 81.51 f | 0.00 g | 90.02 g |
| Trt. No. | Rate | | Time | POROL | SPRAR | SOLSA | KCHSC |
| 1 | — | | — | 0.00 g | 0.00 c | 0.00 g | 0.00 e |
| 2 | 100 | g ai/a | A | 94.45 f | 70.37 b | 54.86 f | 0.00 e |
| 3 | 4.0 | lb/a | A | 98.84 e | 100.00 a | 90.97 e | 95.54 d |
| | 100 | g ai/a | B | | | | |
| 4 | 4.0 | lb/a | A | 99.35 c | 100.00 a | 95.83 c | 98.21 b |
| | 100 | g ai/a | C | | | | |
| 5 | 4.0 | lb/a | A | 99.48 b | 100.00 a | 98.61 a | 97.32 c |
| | 100 | g ai/a | D | | | | |
| 6 | 25 | g ai/a | A | 99.23 d | 100.00 a | 94.44 d | 97.32 c |
| | 4.0 | lb/a | A | | | | |
| | 100 | g ai/a | C | | | | |
| 7 | 50 | g ai/a | A | 99.35 c | 100.00 a | 97.92 b | 95.54 d |
| | 4.0 | lb/a | A | | | | |
| | 100 | g ai/a | C | | | | |
| 8 | 4.0 | lb/a | A | 99.87 a | 100.00 a | 94.44 d | 100.00 a |
| Trt. No. | Rate | | Time | MALNE | IPOHE | MATMT | CHEAL |
| 1 | — | | — | 0.00 f | 0.00 b | 0.00 g | 0.00 f |
| 2 | 100 | g ai/a | A | 0.00 f | 100.00 a | 73.58 c | 36.71 c |
| 3 | 4.0 | lb/a | A | 0.00 f | 100.00 a | 56.60 e | 18.99 d |
| | 100 | g ai/a | B | | | | |
| 4 | 4.0 | lb/a | A | 16.67 d | 100.00 a | 67.92 d | 2.53 e |
| | 100 | g ai/a | C | | | | |
| 5 | 4.0 | lb/a | A | 26.67 c | 100.00 a | 77.36 b | 60.76 a |
| | 100 | g ai/a | D | | | | |
| 6 | 25 | g ai/a | A | 6.67 e | 100.00 a | 54.72 f | 0.00 f |
| | 4.0 | lb/a | A | | | | |
| | 100 | g ai/a | C | | | | |
| 7 | 50 | g ai/a | A | 30.00 b | 100.00 a | 84.91 a | 36.71 c |
| | 4.0 | lb/a | A | | | | |
| | 100 | g ai/a | C | | | | |
| 8 | 4.0 | lb/a | A | 40.00 a | 100.00 a | 0.00 g | 51.90 b |
| Trt. No. | Rate | | Time | CERSS | MEDPO | POLSS | SONSS |
| 1 | — | | — | 0.00 f | 0.00 f | 0.00 b | 0.00 c |
| 2 | 100 | g ai/a | A | 0.00 f | 77.78 b | 0.00 b | 100.00 a |
| 3 | 4.0 | lb/a | A | 61.90 c | 33.33 d | 100.00 a | 50.00 b |
| | 100 | g ai/a | B | | | | |
| 4 | 4.0 | lb/a | A | 47.62 e | 33.33 d | 100.00 a | 50.00 b |
| | 100 | g ai/a | C | | | | |
| 5 | 4.0 | lb/a | A | 66.67 b | 77.78 b | 100.00 a | 100.00 a |
| | 100 | g ai/a | D | | | | |
| 6 | 25 | g ai/a | A | 52.38 d | 66.67 c | 100.00 a | 0.00 c |
| | 4.0 | lb/a | A | | | | |
| | 100 | g ai/a | C | | | | |
| 7 | 50 | g ai/a | A | 71.43 a | 88.89 a | 100.00 a | 100.00 a |
| | 4.0 | lb/a | A | | | | |
| | 100 | g ai/a | C | | | | |
| 8 | 4.0 | lb/a | A | 66.67 b | 22.22 e | 100.00 a | 0.00 c |

Timings for Table 27 are the same as those for Table 20.

TABLE 28
Total Weed Count. Average total broadleaf weed count listed by date per treatment.

| Trt. No. | Rate | | Time | Week 2 | Week 4 | Week 6 | Week 8 |
|---|---|---|---|---|---|---|---|
| 1 | — | | — | 598.75 a | 659.75 a | 732.25 a | 750.75 a |
| 2 | 100 | g ai/a | A | 33.75 b | 116.25 b | 143.00 b | 148.00 b |
| 3 | 4.0 | lb/a | A | 5.75 b | 61.25 b | 87.25 b | 94.25 b |
| | 100 | g ai/a | B | | | | |
| 4 | 4.0 | lb/a | A | 2.75 b | 40.50 b | 65.25 b | 73.50 b |
| | 100 | g ai/a | C | | | | |
| 5 | 4.0 | lb/a | A | 47.25 b | 94.25 b | 111.75 b | 120.00 b |
| | 100 | g ai/a | D | | | | |
| 6 | 25 | g ai/a | A | 0.75 b | 43.00 b | 68.25 b | 74.50 b |
| | 4.0 | lb/a | A | | | | |
| | 100 | g ai/a | C | | | | |
| 7 | 50 | g ai/a | A | 0.25 b | 18.75 b | 34.50 b | 37.75 b |
| | 4.0 | lb/a | A | | | | |
| | 100 | g ai/a | C | | | | |
| 8 | 4.0 | lb/a | A | 150.25 b | 216.25 b | 246.25 b | 254.50 b |

Timings for Table 28 are the same as those for Table 20.

TABLE 29
Percent Control. Average percent control of broadleaf weeds listed by date per treatment.

| Trt. No. | Rate | | Time | Week 2 | Week 4 | Week 6 | Week 8 |
|---|---|---|---|---|---|---|---|
| 1 | — | | — | 0.00 h | 0.00 h | 0.00 h | 0.00 h |
| 2 | 100 | g ai/a | A | 94.36 e | 82.38 f | 80.47 f | 80.29 f |
| 3 | 4.0 | lb/a | A | 99.04 d | 90.72 d | 88.08 d | 87.45 d |
| | 100 | g ai/a | B | | | | |
| 4 | 4.0 | lb/a | A | 99.54 c | 93.86 b | 91.09 b | 90.21 b |
| | 100 | g ai/a | C | | | | |
| 5 | 4.0 | lb/a | A | 92.11 f | 85.71 e | 84.74 e | 84.02 e |
| | 100 | g ai/a | D | | | | |
| 6 | 25 | g ai/a | A | 99.87 b | 93.48 c | 90.68 c | 90.08 c |
| | 4.0 | lb/a | A | | | | |
| | 100 | g ai/a | C | | | | |
| 7 | 50 | g ai/a | A | 99.96 a | 97.16 a | 95.29 a | 94.97 a |
| | 4.0 | lb/a | A | | | | |
| | 100 | g ai/a | C | | | | |
| 8 | 4.0 | lb/a | A | 74.91 g | 67.22 g | 66.37 g | 66.10 g |

Timings for Table 29 are the same as those for Table 20.

Tables 28 and 29 reflect the average total weed count and average percent control for all weeds at weeks 2, 4, 6, and 8 respectively (provided in Tables 20-27) when soils were subjected to treatments according to the application rates and timings. Tables 28 and 29 indicate that treatments 2-8 provided improvement over the control. Tables 28 and 29 also indicate that treatments 2 (thaxtomin 100 g ai/a alone at a single application timing) through 7 (thaxtomin+Kerb® 50-W at various application timings) provide improvement in controlling weeds over treatment 8 (Kerb® 50-W 4 lb/a alone) at weeks 2, 4, 6, and 8.

Tables 28 and 29 also indicate that treatments 3, 4, 6, and 7 (thaxtomin+Kerb® 50-W at various application timings) provided improved weed control over treatment 2 (thaxtomin 100 g ai/a) at weeks 2, 4, 6, and 8. Treatment 5 provided improved weed control over treatment 2 at weeks 4, 6, and 8.

### Example 4

Thaxtomin was applied alone and in combination as a pre-emergence application with Ro-Neet® to evaluate weed control and synergies at different rates and application timings while improving weed control efficacy and weeds controlled in combination if they were not controlled alone.

The trial was set up in Hughson, Calif. in a randomized complete block. The study consisted of eight (8) treatments applied at five distinct application times (i.e., “A”, “B”, “C”, “D”, and “E”). Treatment applications were performed using a CO₂ backpack sprayer with a spray boom incorporating 2 XR TeeJet® flat spray nozzles at 30 psi directed at the soil surface. Drenching applications were performed using a watering can.

The following treatments were applied and correspond to Tables 30-33:
Treatment 1. Untreated check/control (designated as “--”);
Treatment 2. Ro-Neet® 6E applied as a spray at a rate of 2.0 qt/acre at pre-emergence;
Treatment 3. Thaxtomin at 77 mg/L applied at a rate of 100 g ai/acre as a pre-emergence drench;
Treatment 4. Ro-Neet® 6E applied as a spray at a rate of 2.0 qt/acre at pre-emergence rotated with thaxtomin at 77 mg/L applied as a drench at a rate of 100 g ai/acre prior to emergence;
Treatment 5. Ro-Neet® 6E applied as a spray at a rate of 2.0 qt/acre at pre-emergence rotated with thaxtomin at 77 mg/L applied as a drench at a rate of 100 g ai/acre when emergence is approximately 50% or less;
Treatment 6. Ro-Neet® 6E applied as a spray at a rate of 2.0 qt/acre at pre-emergence rotated with thaxtomin at 77 mg/L applied as a drench at a rate of 100 g ai/acre when emergence is 100%;
Treatment 7. Ro-Neet® 6E applied at a rate of 2.0 qt/acre at pre-emergence as a tank mix drench rotated with thaxtomin at 77 mg/L applied at pre-emergence as a tank mix drench at a rate of 25 g ai/acre followed by thaxtomin at 77 mg/L applied as a tank mix drench at a rate of 100 g ai/acre when emergence is approximately a 50% or less; and
Treatment 8. Ro-Neet® 6E applied at a rate of 2.0 qt/acre at pre-emergence as a tank mix drench rotated with thaxtomin at 77 mg/L applied at pre-emergence as a tank mix drench at a rate of 50 g ai/acre followed by thaxtomin at 77 mg/L applied as a tank mix drench at a rate of 100 g ai/acre when emergence is approximately a 50% or less.

Weed control evaluations by species were carried out four times at 2 weeks, 4 weeks, 6 weeks, and 8 weeks from the date of “Time(s) NB.” Timings A and B occurred one day after (i.e., at pre-emergence) the crop of interest (Spinacia oleracea) was direct-seeded. Results are provided in Tables 30-33.

TABLE 30
Percent Control. Average percent control of broadleaf weeds listed by species per treatment
at 2 weeks.

| Trt. No. | Rate | | Time | AMARE | SOLSA | ERAMX | CYPES |
|---|---|---|---|---|---|---|---|
| 1 | — | | — | 0.0 c | 0.0 c | 0.0 c | 0.0 c |
| 2 | 2.0 | qt/a | A | 84.8 b | 70.3 b | 96.8 b | 96.3 a |
| 3 | 100 | g ai/a | B | 94.3 a | 90.0 a | 99.3 a | 89.3 b |
| 4 | 2.0 | qt/a | A | 100.0 a | 100.0 a | 100.0 a | 98.5 a |
| | 100 | g ai/a | C | | | | |
| 5 | 2.0 | qt/a | A | 99.0 a | 98.0 a | 100.0 a | 97.8 a |
| | 100 | g ai/a | D | | | | |
| 6 | 2.0 | qt/a | A | 98.0 a | 97.0 a | 100.0 a | 98.5 a |
| | 100 | g ai/a | E | | | | |
| 7 | 2.0 | qt/a | A | 100.0 a | 99.8 a | 100.0 a | 98.8 a |
| | 25 | g ai/a | B | | | | |
| | 100 | g ai/a | D | | | | |
| 8 | 2.0 | qt/a | A | 97.5 a | 96.3 a | 100.0 a | 99.3 a |
| | 50 | g ai/a | B | | | | |
| | 100 | g ai/a | D | | | | |

Timing A included a spray treatment of 2.0 qt/a of Ro-Neet®; Timing B included a drench treatment of 100 g ai/A of the thaxtomin; Timing C included a drench treatment of 100 g ai/A of the thaxtomin prior to emergence of the crop of interest (Spinacia oleracea) 3 days after planting; Timing D included a drench treatment of 100 g ai/A of the thaxtomin at 50% emergence of the crop of interest (Spinacia oleracea) 7 days after planting; and Timing E included a drench treatment of 100 g ai/A of the thaxtomin at 100% emergence of the crop of interest (Spinacia oleracea) 9 days after planting.

TABLE 31
Percent Control. Average percent control of broadleaf weeds listed by species per treatment
at week 4.

| Trt. No. | Rate | | Time | AMARE | SOLSA | | ERAMX | CYPES |
|---|---|---|---|---|---|---|---|---|
| 1 | — | | — | 0.0 c | 0.0 | c | 0.0 c | 0.0 c |
| 2 | 2.0 | qt/a | A | 50.0 b | 15.0 | c | 55.0 b | 80.0 a |
| 3 | 100 | g ai/a | B | 86.0 a | 58.5 | b | 91.0 a | 43.8 b |
| 4 | 2.0 | qt/a | A | 98.3 a | 96.3 | a | 99.0 a | 87.8 a |
| | 100 | g ai/a | C | | | | | |
| 5 | 2.0 | qt/a | A | 94.5 a | 81.0 | ab | 96.8 a | 90.8 a |
| | 100 | g ai/a | D | | | | | |
| 6 | 2.0 | qt/a | A | 94.0 a | 84.3 | ab | 96.5 a | 82.3 a |
| | 100 | g ai/a | E | | | | | |
| 7 | 2.0 | qt/a | A | 83.0 a | 67.5 | b | 95.8 a | 88.8 a |
| | 25 | g ai/a | B | | | | | |
| | 100 | g ai/a | D | | | | | |
| 8 | 2.0 | qt/a | A | 94.5 a | 85.3 | ab | 96.5 a | 95.3 a |
| | 50 | g ai/a | B | | | | | |
| | 100 | g ai/a | D | | | | | |

Timings for Table 31 are the same as those for Table 30.

TABLE 32
Percent Control. Average percent control of broadleaf weeds listed by species per treatment
at week 6.

| Trt. No. | Rate | | Time | AMARE | SOLSA | | ERAMX | | CYPES | |
|---|---|---|---|---|---|---|---|---|---|---|
| 1 | — | | — | 0.0 d | 0.0 | d | 0.0 | d | 0.0 | d |
| 2 | 2.0 | qt/a | A | 40.8 c | 0.0 | d | 24.5 | c | 54.8 | c |
| 3 | 100 | g ai/a | B | 69.3 b | 23.8 | c | 74.3 | b | 22.8 | d |
| 4 | 2.0 | qt/a | A | 94.3 a | 90.3 | a | 94.3 | a | 79.5 | a |
| | 100 | g ai/a | C | | | | | | | |
| 5 | 2.0 | qt/a | A | 90.5 a | 66.3 | b | 90.0 | ab | 71.0 | abc |
| | 100 | g ai/a | D | | | | | | | |
| 6 | 2.0 | qt/a | A | 91.5 a | 73.5 | b | 87.5 | ab | 55.0 | bc |
| | 100 | g ai/a | E | | | | | | | |
| 7 | 2.0 | qt/a | A | 86.8 a | 72.8 | b | 83.8 | ab | 78.5 | ab |
| | 25 | g ai/a | B | | | | | | | |
| | 100 | g ai/a | D | | | | | | | |
| 8 | 2.0 | qt/a | A | 91.0 a | 78.3 | ab | 92.0 | a | 84.3 | a |
| | 50 | g ai/a | B | | | | | | | |
| | 100 | g ai/a | D | | | | | | | |

Timings for Table 32 are the same as those for Table 30.

TABLE 33
Percent Control. Average percent control of broadleaf weeds listed by species per treatment
at week 8.

| Trt. No. | Rate | | Time | AMARE | | SOLSA | | ERAMX | | CYPES | |
|---|---|---|---|---|---|---|---|---|---|---|---|
| 1 | — | | — | 0.0 | d | 0.0 | c | 0.0 | c | 0.0 | c |
| 2 | 2.0 | qt/a | A | 0.0 | d | 0.0 | c | 0.0 | c | 0.0 | c |
| 3 | 100 | g ai/a | B | 0.0 | d | 0.0 | c | 0.0 | c | 0.0 | c |
| 4 | 2.0 | qt/a | A | 78.5 | a | 60.0 | a | 76.3 | a | 44.0 | a |
| | 100 | g ai/a | C | | | | | | | | |
| 5 | 2.0 | qt/a | A | 69.3 | ab | 18.8 | bc | 51.8 | ab | 32.5 | ab |
| | 100 | g ai/a | D | | | | | | | | |
| 6 | 2.0 | qt/a | A | 33.5 | bcd | 11.8 | c | 38.3 | b | 18.0 | bc |
| | 100 | g ai/a | E | | | | | | | | |
| 7 | 2.0 | qt/a | A | 30.8 | cd | 15.3 | bc | 26.3 | bc | 22.5 | abc |
| | 25 | g ai/a | B | | | | | | | | |
| | 100 | g ai/a | D | | | | | | | | |
| 8 | 2.0 | qt/a | A | 59.3 | abc | 36.5 | b | 53.0 | ab | 37.0 | ab |
| | 50 | g ai/a | B | | | | | | | | |
| | 100 | g ai/a | D | | | | | | | | |

Timings for Table 33 are the same as those for Table 30.

Tables 30-33 indicate that treatments 4-8 (Ro-Neet®+thaxtomin) improved the weed control compared to treatment 2 (Ro-Neet® alone) and treatment 3 (thaxtomin alone) at weeks 2, 4, 6, and 8.

### Example 5

Thaxtomin was applied alone and in combination as a pre-emergence application with trifluralin to evaluate weed control and synergies at different rates and application timings while improving weed control efficacy and weeds controlled in combination if they were not controlled alone.

The trial was set up in Hughson, Calif. in a randomized complete block. The study consisted of eight (8) treatments applied at six distinct application times (i.e., “A”, “B”, “C”, “D”, “E”, and “F”). Treatment applications were performed using a CO₂ backpack sprayer with a spray boom incorporating 2 XR TeeJet® flat spray nozzles at 30 psi directed at the soil surface. Drenching applications were performed using a watering can.

The following treatments were applied applications following the immediate transplant of the crop of interest (Brassica oleracea capitata alba) and correspond to Tables 34-37:
Treatment 1. Untreated check/control (designated as “--”);
Treatment 2. Trifluralin applied at day zero (0) as a spray at a rate of 1.25 pt/acre at transplant;
Treatment 3. Trifluralin applied at day zero (0) as a spray at a rate of 1.25 pt/acre at transplant followed by an application of thaxtomin at 77 mg/L applied at three (3) days post transplant as drench at a rate of 100 g ai/acre;
Treatment 4. Trifluralin applied at day zero (0) as a spray at a rate of 1.25 pt/acre at transplant followed by an application of thaxtomin at 77 mg/L applied at five (5) days post transplant as drench at a rate of 100 g ai/acre;
Treatment 5. Trifluralin applied at day zero (0) as a spray at a rate of 1.25 pt/acre at transplant followed by an application of thaxtomin at 77 mg/L applied at seven (7) days post transplant as drench at a rate of 100 g ai/acre;
Treatment 6. Trifluralin applied at day zero (0) as a spray at a rate of 1.25 pt/acre at transplant followed by an application of thaxtomin at 77 mg/L applied at nine (9) days post transplant as drench at a rate of 100 g ai/acre;
Treatment 7. Trifluralin applied at day zero (0) as a spray at a rate of 1.25 pt/acre at transplant followed by an application of thaxtomin at 77 mg/L applied at eleven (11) days post transplant as drench at a rate of 100 g ai/acre; and
Treatment 8. Thaxtomin at 77 mg/L applied at day zero (0) as a spray at a rate of 100 g ai/acre;

Weed control evaluations were carried out by species and evaluated at 2 weeks, 4 weeks, 6 weeks and 8 weeks from the date of “Time A.” Results are provided in Tables 34-37.

TABLE 34
Percent Control. Average percent control of broadleaf
weeds listed by species per treatment at 2 weeks.

| Trt. No. | Rate | | Time | SOLSA | POROL | ERAMX |
|---|---|---|---|---|---|---|
| 1 | — | | — | 0.0 | 0.0 | 0.0 |
| 2 | 1.25 | pt/a | A | 50.5 | 75.0 | 92.0 |
| 3 | 1.25 | pt/a | A | 99.0 | 99.5 | 99.8 |
| | 100 | g ai/a | B | | | |
| 4 | 1.25 | pt/a | A | 99.0 | 99.5 | 99.8 |
| | 100 | g ai/a | C | | | |
| 5 | 1.25 | pt/a | A | 99.0 | 99.5 | 100.0 |
| | 100 | g ai/a | D | | | |
| 6 | 1.25 | pt/a | A | 98.8 | 97.3 | 99.8 |
| | 100 | g ai/a | E | | | |
| 7 | 1.25 | pt/a | A | 89.8 | 89.5 | 98.3 |
| | 100 | g ai/a | F | | | |
| 8 | 100 | g ai/a | A | 96.3 | 98.5 | 100.0 |

Timing A included a spray treatment of 1.25 pt/a of trifluralin at day zero (0)/immediately following transplant of the crop of interest (Brassica oleracea capitata alba); Timing B included a drench treatment of 100 g ai/A of thaxtomin at three (3) days post-transplant of the crop of interest (Brassica oleracea capitata alba);Timing C included a drench treatment of 100 g ai/A of thaxtomin at five (5) days post-transplant of the crop of interest (Brassica oleracea capitata alba); Timing D included a drench treatment of 100 g ai/A of thaxtomin at seven (7) days post-transplant of the crop of interest (Brassica oleracea capitata alba); Timing E included a drench treatment of 100 g ai/A of thaxtomin at nine (9) days post-transplant of the crop of interest (Brassica oleracea capitata alba);and Timing F included a drench treatment of 100 g ai/A of thaxtomin at eleven (11) days post-transplant of the crop of interest (Brassica oleracea capitata alba).

TABLE 35
Percent Control. Average percent control of broadleaf
weeds listed by species per treatment at 4 weeks.

| Trt. No. | Rate | | Time | SOLSA | POROL | ERAMX |
|---|---|---|---|---|---|---|
| 1 | — | | — | 0.0 | 0.0 | 0.0 |
| 2 | 1.25 | pt/a | A | 34.8 | 62.5 | 82.5 |
| 3 | 1.25 | pt/a | A | 91.8 | 96.0 | 96.5 |
| | 100 | g ai/a | B | | | |
| 4 | 1.25 | pt/a | A | 86.8 | 89.0 | 96.3 |
| | 100 | g ai/a | C | | | |
| 5 | 1.25 | pt/a | A | 94.3 | 93.5 | 96.3 |
| | 100 | g ai/a | D | | | |
| 6 | 1.25 | pt/a | A | 92.0 | 92.3 | 97.5 |
| | 100 | g ai/a | E | | | |
| 7 | 1.25 | pt/a | A | 81.3 | 80.5 | 93.8 |
| | 100 | g ai/a | F | | | |
| 8 | 100 | g ai/a | A | 88.8 | 83.0 | 93.8 |

Timings for Table 35 are the same as those for Table 34.

TABLE 36
Percent Control. Average percent control of broadleaf
weeds listed by species per treatment at 6 weeks.

| Trt. No. | Rate | | Time | SOLSA | POROL | ERAMX |
|---|---|---|---|---|---|---|
| 1 | — | | — | 0.0 | 0.0 | 0.0 |
| 2 | 1.25 | pt/a | A | 18.8 | 38.8 | 63.8 |
| 3 | 1.25 | pt/a | A | 68.0 | 70.8 | 73.5 |
| | 100 | g ai/a | B | | | |
| 4 | 1.25 | pt/a | A | 73.3 | 72.5 | 84.3 |
| | 100 | g ai/a | C | | | |
| 5 | 1.25 | pt/a | A | 79.8 | 75.8 | 86.3 |
| | 100 | g ai/a | D | | | |
| 6 | 1.25 | pt/a | A | 69.5 | 63.5 | 85.0 |
| | 100 | g ai/a | E | | | |
| 7 | 1.25 | pt/a | A | 61.5 | 69.5 | 82.8 |
| | 100 | g ai/a | F | | | |
| 8 | 100 | g ai/a | A | 74.3 | 67.0 | 76.5 |

Timings for Table 36 are the same as those for Table 34.

TABLE 37
Percent Control. Average percent control of broadleaf
weeds listed by species per treatment at 8 weeks.

| Trt. No. | Rate | | Time | SOLSA | POROL | ERAMX |
|---|---|---|---|---|---|---|
| 1 | — | | — | 0.0 | 0.0 | 0.0 |
| 2 | 1.25 | pt/a | A | 14.3 | 35.0 | 55.5 |
| 3 | 1.25 | pt/a | A | 63.8 | 65.0 | 69.3 |
| | 100 | g ai/a | B | | | |
| 4 | 1.25 | pt/a | A | 62.5 | 67.3 | 77.5 |
| | 100 | g ai/a | C | | | |
| 5 | 1.25 | pt/a | A | 69.5 | 68.5 | 77.5 |
| | 100 | g ai/a | D | | | |
| 6 | 1.25 | pt/a | A | 59.5 | 52.0 | 70.0 |
| | 100 | g ai/a | E | | | |
| 7 | 1.25 | pt/a | A | 46.3 | 53.8 | 70.8 |
| | 100 | g ai/a | F | | | |
| 8 | 100 | g ai/a | A | 64.5 | 55.3 | 66.5 |

Timings for Table 37 are the same as those for Table 34.

Tables 34-37 indicate that treatments 3-7 (trifluralin+thaxtomin at various timings) improved the weed control compared to treatment 2 (trifluralin alone at a single timing) at weeks 2, 4, 6, and 8. Treatment 8 (thaxtomin alone) also performed well in controlling weeds. At weeks 2, 4, 6, and 8, results indicate that comparisons in weed control between treatments 3-7 and treatment 8 was often weed specific.

### Example 6

Similar to Example 5, thaxtomin was applied alone and in combination as a pre-emergence application with trifluralin to evaluate weed control and synergies at different rates and application timings while improving weed control efficacy and weeds controlled in combination if they were not controlled alone.

The trial was set up in Hughson, Calif. in a randomized complete block. The study consisted of eight (8) treatments applied at five distinct application times (i.e., “A”, “B”, “C”, “D”, and “E”). Treatment applications were performed using a CO₂ backpack sprayer with a spray boom incorporating 2 XR TeeJet® flat spray nozzles at 30 psi directed at the soil surface. Drenching applications were performed using a watering can. The treatments consisted of the following applications following the immediate transplant of the crop of interest (Brassica oleracea capitata alba) and correspond to Tables 38-41:
Treatment 1. Untreated check/control (designated as “--”);
Treatment 2. Trifluralin applied at day zero (0) as a spray at a rate of 1.25 pt/acre at transplant;
Treatment 3. Trifluralin applied at day zero (0) as a spray at a rate of 1.25 pt/acre at transplant followed by an application of thaxtomin at 77 mg/L applied at day zero (0) as a drench at a rate of at a rate of 25 g ai/acre;
Treatment 4. Trifluralin applied at day zero (0) as a spray at a rate of 1.25 pt/acre at transplant followed by an application of thaxtomin at 77 mg/L applied at day zero (0) as a drench at a rate of at a rate of 50 g ai/acre;
Treatment 5. Trifluralin applied at day zero (0) as a spray at a rate of 1.25 pt/acre at transplant followed by an application of thaxtomin at 77 mg/L applied at day zero (0) as a drench at a rate of at a rate of 25 g ai/acre followed by an application of thaxtomin at 77 mg/L applied at four (4) days post-transplant as drench at a rate of 100 g ai/acre;
Treatment 6. Trifluralin applied at day zero (0) as a spray at a rate of 1.25 pt/acre at transplant followed by an application of thaxtomin at 77 mg/L applied at day zero (0) as a drench at a rate of at a rate of 50 g ai/acre followed by an application of thaxtomin at 77 mg/L applied at four (4) days post-transplant as drench at a rate of 100 g ai/acre;
Treatment 7. Trifluralin applied at day zero (0) as a spray at a rate of 1.25 pt/acre at transplant followed by an application of thaxtomin at 77 mg/L applied at day zero (0) as a drench at a rate of at a rate of 25 g ai/acre followed by an application of thaxtomin at 77 mg/L applied at eight (8) days post-transplant as drench at a rate of 100 g ai/acre; and
Treatment 8. Trifluralin applied at day zero (0) as a spray at a rate of 1.25 pt/acre at transplant followed by an application of thaxtomin at 77 mg/L applied at day zero (0) as a drench at a rate of at a rate of 50 g ai/acre followed by an application of thaxtomin at 77 mg/L applied at eight (8) days post-transplant as drench at a rate of 100 g ai/acre.

Weed control evaluations were carried out by species and evaluated at 2 weeks, 4 weeks, 6 weeks and 8 weeks from the date of “Time(s) A/B/C.” Timings A, B, and C, occurred at the time the crop of interest (Brassica oleracea capitata alba) was transplanted. Results are provided in Tables 38-41.

TABLE 38
Percent Control. Average percent control of broadleaf
weeds listed by species per treatment at 2 weeks.

| Trt. No. | Rate | | Time | POROL | AMARE | LAMAM |
|---|---|---|---|---|---|---|
| 1 | — | | — | 0.0 c | 0.0 c | 0.0 d |
| 2 | 1.25 | pt/a | A | 99.0 b | 94.3 b | 80.0 c |
| 3 | 1.25 | pt/a | A | 100.0 a | 99.5 a | 97.3 ab |
| | 25 | g ai/a | B | | | |
| 4 | 1.25 | pt/a | A | 99.5 ab | 100.0 a | 97.3 ab |
| | 50 | g ai/a | C | | | |
| 5 | 1.25 | pt/a | A | 100.0 a | 99.8 a | 98.0 ab |
| | 25 | g ai/a | B | | | |
| | 100 | g ai/a | D | | | |
| 6 | 1.25 | pt/a | A | 100.0 a | 100.0 a | 99.5 a |
| | 50 | g ai/a | C | | | |
| | 100 | g ai/a | D | | | |
| 7 | 1.25 | pt/a | A | 99.5 ab | 99.0 a | 94.0 b |
| | 25 | g ai/a | B | | | |
| | 100 | g ai/a | E | | | |
| 8 | 1.25 | pt/a | A | 99.5 ab | 99.8 a | 99.8 a |
| | 50 | g ai/a | C | | | |
| | 100 | g ai/a | E | | | |

Timing A included a spray treatment of 1.25 pt/a of trifluralin at day zero (0)/immediately following transplant of the crop of interest (Brassica oleracea capitata alba); Timing B included a spray treatment of 25 g ai/A of thaxtomin at transplant of the crop of interest (Brassica oleracea capitata alba); Timing C included a drench treatment of 50 g ai/A of thaxtomin at transplant of the crop of interest (Brassica oleracea capitata alba); Timing D included a drench treatment of 100 g ai/A of thaxtomin at four (4) days post-transplant of the crop of interest (Brassica oleracea capitata alba); and Timing E included a drench treatment of 100 g ai/A of thaxtomin at eight (8) days post-transplant of the crop of interest (Brassica oleracea capitata alba).

TABLE 39
Percent Control. Average percent control of broadleaf weeds listed by species per treatment
at 4 weeks.

| Trt. No. | Rate | | Time | URTUR | | AMARE | | LAMAM | | SOLSA | |
|---|---|---|---|---|---|---|---|---|---|---|---|
| 1 | — | | — | 0.0 | c | 0.0 | c | 0.0 | e | 0.0 | f |
| 2 | 1.25 | pt/a | A | 72.3 | b | 96.3 | b | 56.8 | d | 31.8 | e |
| 3 | 1.25 | pt/a | A | 85.5 | ab | 96.8 | ab | 79.5 | bc | 45.5 | de |
| | 25 | g ai/a | B | | | | | | | | |
| 4 | 1.25 | pt/a | A | 92.8 | a | 97.3 | ab | 88.3 | ab | 66.8 | bcd |
| | 50 | g ai/a | C | | | | | | | | |
| 5 | 1.25 | pt/a | A | 99.5 | a | 100.0 | a | 93.8 | a | 86.5 | ab |
| | 25 | g ai/a | B | | | | | | | | |
| | 100 | g ai/a | D | | | | | | | | |
| 6 | 1.25 | pt/a | A | 99.8 | a | 100.0 | a | 94.5 | a | 91.0 | a |
| | 50 | g ai/a | C | | | | | | | | |
| | 100 | g ai/a | D | | | | | | | | |
| 7 | 1.25 | pt/a | A | 95.8 | a | 99.3 | ab | 74.5 | c | 51.3 | cde |
| | 25 | g ai/a | B | | | | | | | | |
| | 100 | g ai/a | E | | | | | | | | |
| 8 | 1.25 | pt/a | A | 98.8 | a | 99.5 | ab | 86.3 | ab | 74.0 | abc |
| | 50 | g ai/a | C | | | | | | | | |
| | 100 | g ai/a | E | | | | | | | | |

Timings for Table 39 are the same as those for Table 38.

TABLE 40
Percent Control. Average percent control of broadleaf weeds listed by species per treatment
6 weeks.

| Trt. No. | Rate | | Time | URTUR | | AMARE | | LAMAM | | SOLSA | |
|---|---|---|---|---|---|---|---|---|---|---|---|
| 1 | — | | — | 0.0 | e | 0.0 | c | 0.0 | d | 0.0 | d |
| 2 | 1.25 | pt/a | A | 26.3 | de | 76.3 | b | 23.8 | c | 13.8 | cd |
| 3 | 1.25 | pt/a | A | 54.5 | cd | 85.3 | ab | 37.5 | c | 13.5 | cd |
| | 25 | g ai/a | B | | | | | | | | |
| 4 | 1.25 | pt/a | A | 61.3 | bc | 86.0 | ab | 78.3 | ab | 37.0 | bc |
| | 50 | g ai/a | C | | | | | | | | |
| 5 | 1.25 | pt/a | A | 95.3 | a | 99.5 | a | 90.3 | a | 76.8 | a |
| | 25 | g ai/a | B | | | | | | | | |
| | 100 | g ai/a | D | | | | | | | | |
| 6 | 1.25 | pt/a | A | 93.8 | a | 99.0 | a | 90.5 | a | 80.0 | a |
| | 50 | g ai/a | C | | | | | | | | |
| | 100 | g ai/a | D | | | | | | | | |
| 7 | 1.2 | 5 pt/a | A | 81.5 | abc | 95.8 | a | 63.8 | b | 24.0 | cd |
| | 25 | g ai/a | B | | | | | | | | |
| | 100 | g ai/a | E | | | | | | | | |
| 8 | 1.25 | pt/a | A | 89.5 | ab | 97.5 | a | 86.0 | a | 59.5 | ab |
| | 50 | g ai/a | C | | | | | | | | |
| | 100 | g ai/a | E | | | | | | | | |

Timings for Table 40 are the same as those for Table 38.

TABLE 41
Percent Control. Average percent control of broadleaf weeds listed by species per treatment
at 8 weeks.

| Trt. No. | Rate | | Time | URTUR | | AMARE | | LAMAM | | SOLSA | |
|---|---|---|---|---|---|---|---|---|---|---|---|
| 1 | — | | — | 0.0 | d | 0.0 | d | 0.0 | e | 0.0 | d |
| 2 | 1.25 | pt/a | A | 18.8 | d | 68.0 | c | 18.0 | d | 8.5 | cd |
| 3 | 1.25 | pt/a | A | 50.0 | c | 76.5 | bc | 32.5 | d | 8.8 | cd |
| | 25 | g ai/a | B | | | | | | | | |
| 4 | 1.25 | pt/a | A | 59.3 | bc | 81.8 | abc | 71.0 | bc | 30.3 | bc |
| | 50 | g ai/a | C | | | | | | | | |
| 5 | 1.25 | pt/a | A | 89.0 | a | 98.8 | a | 89.3 | a | 77.5 | a |
| | 25 | g ai/a | B | | | | | | | | |
| | 100 | g ai/a | D | | | | | | | | |
| 6 | 1.25 | pt/a | A | 92.0 | a | 98.0 | a | 88.0 | a | 73.3 | a |
| | 50 | g ai/a | C | | | | | | | | |
| | 100 | g ai/a | D | | | | | | | | |
| 7 | 1.25 | pt/a | A | 78.3 | ab | 91.8 | ab | 58.8 | c | 16.0 | cd |
| | 25 | g ai/a | B | | | | | | | | |
| | 100 | g ai/a | E | | | | | | | | |
| 8 | 1.25 | pt/a | A | 87.3 | ab | 95.5 | ab | 84.3 | ab | 53.0 | ab |
| | 50 | g ai/a | C | | | | | | | | |
| | 100 | g ai/a | E | | | | | | | | |

Timings for Table 41 are the same as those for Table 38.

Results from Tables 38-41 indicate that treatments 3-8 (trifluralin+thaxtomin at various timings) generally improved the weed control compared to treatment 2 (trifluralin alone at a single timing) at weeks 2, 4, 6, and 8. Exceptions include treatments 3-8 performing about the same as treatment 2 in controlling the weed common purslane (POROL) at week 2, treatment 3 performing about the same as treatment 2 in controlling the weed redroot pigweed (AMARE) at week 4, and treatment 3 performing about the same as treatment 2 in controlling the weed hairy nightshade (SOLSA) at weeks 6 and 8.

It will be understood that various modifications may be made to the embodiments disclosed herein. Therefore, the above description should not be construed as limiting, but merely as exemplifications of embodiments. Those skilled in art will envision other modifications within the scope and spirit of the claims appended hereto.

1. A method of controlling a weed population in an environment, comprising contacting weed population in an environment or an environment susceptible to growth by a weed population with one or more thaxtomins and one or more herbicides selected from the group consisting of pronamide, cycloate, and trifluralin, wherein the one or more thaxtomins and the one or more herbicides are applied in an amount effective to control the weed population in the environment.

2. A method in accordance with claim 1, wherein the one or more thaxtomins include compounds selected from the group consisting of thaxtomin A, thaxtomin B, thaxtomin D, and combinations thereof.

3. A method in accordance with claim 1, wherein the one or more thaxtomins comprise thaxtomin A.

4. A method in accordance with claim 1, wherein said weed population to be treated is a pre-emergent weed population.

5. A method in accordance with claim 1, comprising contacting the environment with the one or more thaxtomins before or after contacting the environment with the one or more herbicides

6. A method in accordance with claim 1, comprising contacting the environment with the one or more thaxtomins simultaneously with the one or more herbicides.

7. A method in accordance with claim 1, wherein the contacting occurs before the weed population has emerged.

8. A method in accordance with claim 1, wherein the contacting occurs after the weed population has emerged.

9. A method in accordance with claim 1, wherein method is applied at least twice and the contacting occurs before and after the weed population has emerged.

10. A method in accordance with claim 1, wherein the contacting prevents the growth of a weed population.

11. The method according to claim 10, wherein the one or more thaxtomins comprise thaxtomin A.

12. A method in accordance with claim 1, wherein the contacting eliminates or reduces the weed population.

13. The method according to claim 12, wherein the one or more thaxtomins comprise thaxtomin A.

14. The method of claim 1, wherein the environment is a soil.

15. The method of claim 1, wherein the environment is a turf.

16. The method of claim 1, wherein the environment is a field.

17. The method of claim 1, wherein the environment is a grass.

18. The method of claim 1, wherein the environment is aquatic.

19. The method of claim 1, wherein the one or more thaxtomins has the following composition: 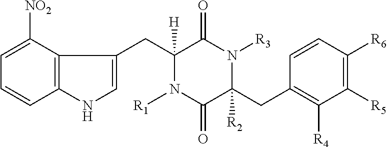
wherein R₁ is methyl or H, R₂ is hydroxy or H, R₃ is methyl or H, R₄ is hydroxy or H, R₅ is hydroxy or H, R₆ is hydroxy or H, and combinations thereof.

20. The method according to claim 19 wherein R₁ is methyl, R₂ is hydroxy, R₃ is methyl, R₄ is H, R₅ is hydroxy and R₆ is H.

21. The method according to claim 1, wherein the one or more thaxtomins are purified thaxtomins, synthetic thaxtomins, recombinant thaxtomins, or a combination thereof.

22. A composition for controlling a weed population comprising one or more thaxtomins, and one or more herbicides selected from the group consisting of pronamide, cycloate, and trifluralin, wherein the one or more thaxtomins and the one or more herbicides are present in an amount effective to control the weed population in an environment.

23. The composition of claim 22, wherein the one or more thaxtomins has the following composition: 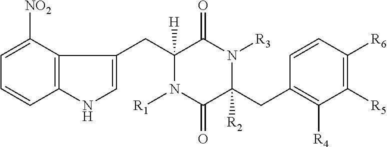
wherein R₁ is methyl or H, R₂ is hydroxy or H, R₃ is methyl or H, R₄ is hydroxy or H, R₅ is hydroxy or H, R₆ is hydroxy or H, and combinations thereof.

24. The composition of claim 23, wherein R₁ is methyl, R₂ is hydroxy, R₃ is methyl, R₄ is H, R₅ is hydroxy and R₆ is H.

25. The composition of claim 22, wherein the one or more thaxtomins include compounds selected from the group consisting of thaxtomin A, thaxtomin B, thaxtomin D, and combinations thereof.

26. The composition of claim 22, wherein the one or more thaxtomins comprise thaxtomin A.

27. The composition of claim 22, wherein the one or more thaxtomins are purified thaxtomins, synthetic thaxtomins, recombinant thaxtomins, or a combination thereof.
